(19) United States
(12) Patent Application Publication
(10) Pub. No.: US 2016/0178813 A1
(43) Pub. Date: Jun. 23, 2016

(54) PHOTOSENSITIVE RESIN COMPOSITION AND USES THEREOF

(71) Applicant: CHI MEI CORPORATION, TAINAN CITY (TW)

(72) Inventors: HAO-WEI LIAO, TAINAN CITY (TW); YU-JIE TSAI, TAINAN CITY (TW)

(21) Appl. No.: 14/968,720

(22) Filed: Dec. 14, 2015

Related U.S. Application Data
(63) Continuation-in-part of application No. 14/614,377, filed on Feb. 4, 2015.

(30) Foreign Application Priority Data
Dec. 19, 2014 (TW) 103144623

(51) Int. Cl. G02B 5/00; G02F 1/1335; G02B 1/04

(52) U.S. Cl. CPC G02B 5/003; G02B 1/04; G02F 1/133512

(57) ABSTRACT

The invention relates to a photosensitive resin composition for a black matrix, a color filter and a liquid crystal display element formed by the black matrix. The photosensitive resin composition comprises an alkali-soluble resin (A), a compound (B) containing an ethylenically unsaturated group, a photoinitiator (C), a solvent (D) and a black pigment (E). The photosensitive resin composition for the black matrix has the advantage of improving resolution and taper angle.

### BACKGROUND OF THE INVENTION

1. Field of the Invention

The invention relates to a photosensitive resin composition for a black matrix, a color filter and a liquid crystal display element formed by the black matrix. More particularly, the invention provides a photosensitive resin composition for a black matrix which can improve resolution and taper angle, a color filter and a liquid crystal display element formed by the black matrix.

2. Description of the Related Art

In recent years, a variety of liquid crystal display techniques have been developed, and in order to improve the contrast and display quality of the current liquid crystal display element, a black matrix is usually disposed in the gap of stripes and dots of the color filter in the display element. The black matrix can prevent issues such as decreases in contrast and color purity caused by light leakage between pixels. A material used in the conventional black matrix is mainly an evaporated film containing, for instance, chromium or chromium oxide. However, when the evaporated film is used as the material of the black matrix, disadvantages such as complicated process and costly materials exist. To solve these problems, a technique of forming the black matrix by a method of using a photosensitive resin composition through photolithography has previously been proposed.

Currently, the demand for shading property of the black matrix is increasing, and one of the solutions is to increase the content of the black pigment, thereby improving the shading property of the black matrix. For instance, JP 2006-259716 discloses a photosensitive resin composition for a black matrix. The photosensitive resin composition includes a high content of a black pigment, an alkali-soluble resin, a photopolymerization initiator, a reactive monomer having two functional groups, and an organic solvent. In particular, the reactive monomer having two functional groups can improve the reaction between the compounds to form a pattern with high fineness. Therefore, in the photosensitive resin composition, when improving the shading property by a manner of increasing the content of the black pigment, the taper angle of the photosensitive resin composition can still be maintained.

Further, JP 2008-268854 discloses a photosensitive resin composition for a black matrix. The photosensitive resin composition includes an alkali-soluble resin having a carboxylic acid group and an unsaturated group, a photopolymerized monomer having an ethylenically unsaturated group, a photopolymerization initiator, and a high content of black pigment. The photosensitive resin composition for the black matrix improves the resolution of the photosensitive resin composition having the high content of black pigment by using the specific alkali-soluble resin.

Although the conventional photosensitive resin compositions having increased content of the black pigment can increase the resolution, the resolution and the taper angle of the conventional photosensitive resin compositions mentioned above cannot be accepted in the field. Therefore, a photosensitive resin composition for a black matrix which can improve the resolution and taper angle is still required.

### SUMMARY OF THE INVENTION

In the present invention, a specific alkali-soluble resin and a specific photoinitiator are provided to obtain a photosensitive resin composition for a black matrix having excellent resolution and taper angle.

Therefore, the present invention provides a photosensitive resin composition comprising:

an alkali-soluble resin (A);

a compound (B) containing an ethylenically unsaturated group;

a photoinitiator (C);

a solvent (D); and

a black pigment (E);

wherein:
the alkali-soluble resin (A) comprises a first alkali-soluble resin (A-1) represented by Formula (1):

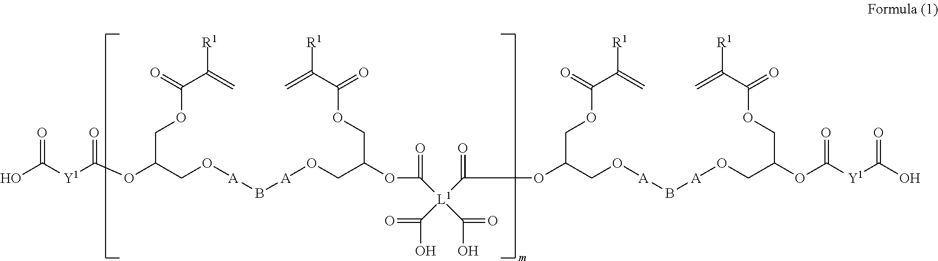

in Formula (1):

A represents a phenylene group or a phenylene group having a substituent, wherein the substituent is a C₁-C₅ alkyl group, a halogen atom, or a phenyl group;

B represents —CO—, —SO₂—, —C(CF₃)₂—, —Si(CH₃)₂—, —CH₂—, —C(CH₃)₂—, —O—, 9,9-fluorenylidene or a single bond;

L¹ represents a tetravalent carboxylic acid residue containing a fluorine atom or a tetravalent carboxylic acid residue without a fluorine atom;

Y¹ represents a divalent carboxylic acid residue containing a fluorine atom or a divalent carboxylic acid residue without a fluorine atom;

R¹ represents a hydrogen atom or a methyl group; and

m represents an integer of 1 to 20;

wherein at least one of L¹ and Y¹ contains the fluorine atom;

the photoinitiator (C) comprises an α-keto oxime ester compound (C-1) represented by Formula (7):

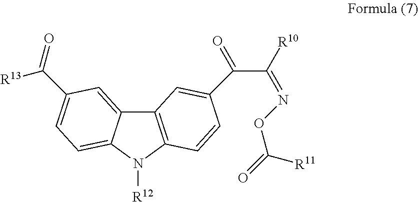

in Formula (7):

R¹⁰ represents a methylbenzene group having 1 to 5 methyl groups;

R¹¹ represents a C₁-C₁₀ alkyl group, a benzoyl group, or a C₃-C₆ cycloalkyl group,

R¹² represents a methyl group, an ethyl group, a propyl group or a benzoyl group; and

R¹³ represents —H,

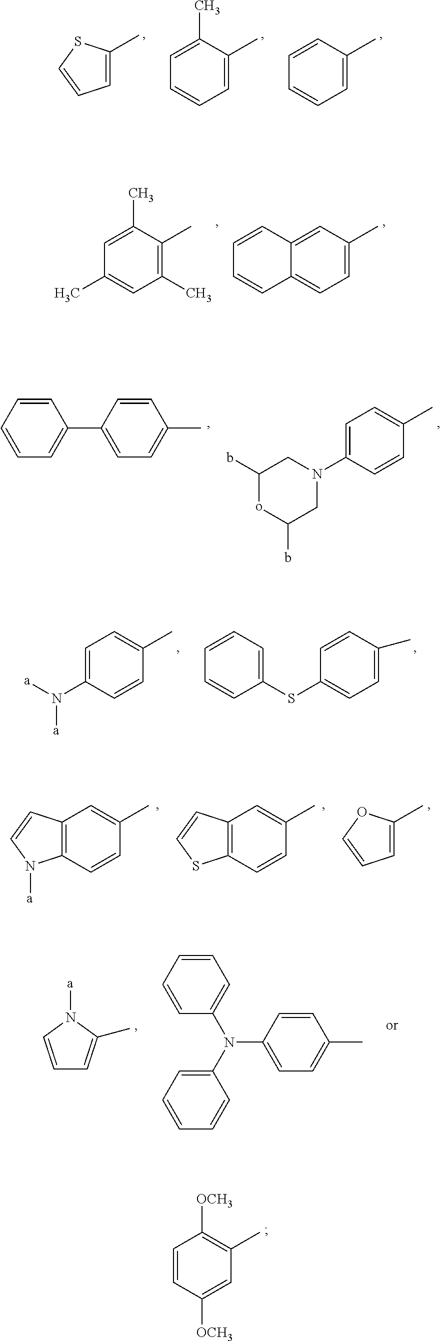

wherein, a represents a methyl group or an ethyl group; and

b represents —H or a methyl group.

The present invention also provides a black matrix formed by the photosensitive resin composition as mentioned above.

The present invention also provides a color filter comprising the black matrix as mentioned above.

The present invention further provides a liquid crystal display element comprising the color filter as mentioned above.

### BRIEF DESCRIPTION OF THE DRAWINGS

FIG. 1 is a schematic diagram showing the relationship between a taper angle and a photoresist pattern under the scanning electron microscope.

### DETAILED DESCRIPTION OF THE INVENTION

The present invention provides a photosensitive resin composition comprising:

an alkali-soluble resin (A);

a compound (B) containing an ethylenically unsaturated group;

a photoinitiator (C);

a solvent (D); and

a black pigment (E);

wherein:

the alkali-soluble resin (A) comprises a first alkali-soluble resin (A-1) represented by Formula (1):

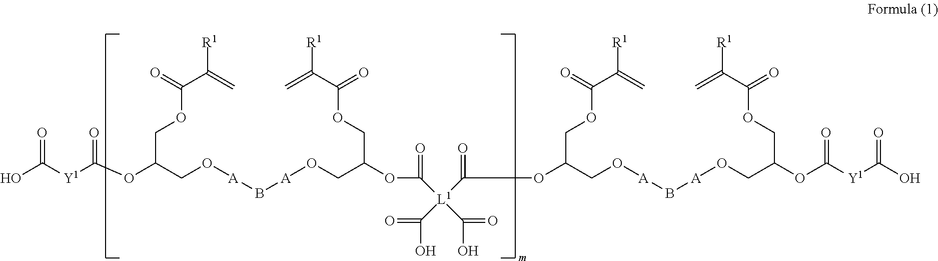

in Formula (1):

A represents a phenylene group or a phenylene group having a substituent, wherein the substituent is a C₁-C₅ alkyl group, a halogen atom, or a phenyl group;

B represents —CO—, —SO₂—, —C(CF₃)₂—, —Si(CH₃)₂—, —CH₂—, —C(CH₃)₂—, —O—, 9,9-fluorenylidene or a single bond;

L¹ represents a tetravalent carboxylic acid residue containing a fluorine atom or a tetravalent carboxylic acid residue without a fluorine atom;

Y¹ represents a divalent carboxylic acid residue containing a fluorine atom or a divalent carboxylic acid residue without a fluorine atom;

R¹ represents a hydrogen atom or a methyl group; and

m represents an integer of 1 to 20;

wherein at least one of L¹ and Y¹ contains the fluorine atom;

the photoinitiator (C) comprises an α-keto oxime ester compound (C-1) represented by Formula (7):

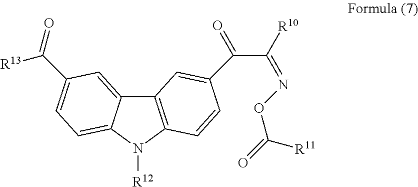

in Formula (7):

R¹⁰ represents a methylbenzene group having 1 to 5 methyl groups;

R¹¹ represents a C₁-C₁₀ alkyl group, a benzoyl group, or a C₃-C₆ cycloalkyl group,

R¹² represents a methyl group, an ethyl group, a propyl group or a benzoyl group; and

R¹³ represents —H,

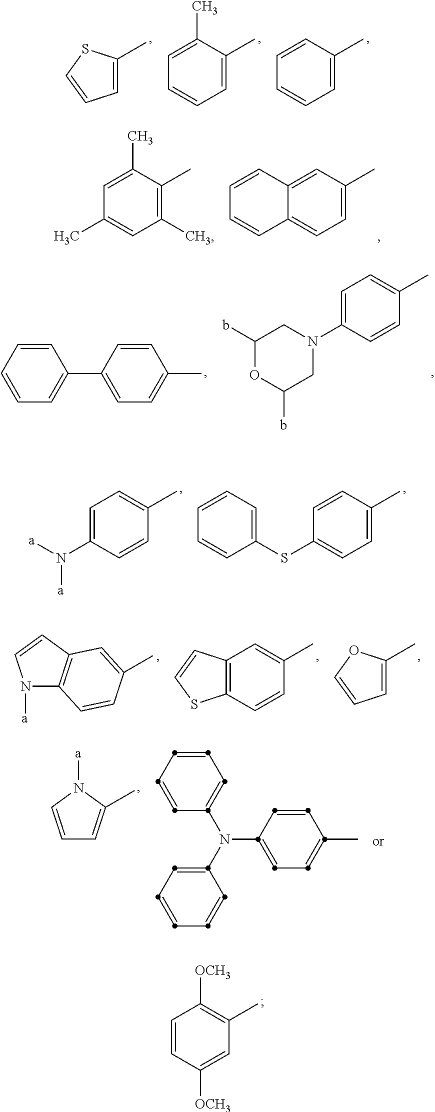

wherein, a represents a methyl group or an ethyl group; and

b represents —H or a methyl group.

The alkali-soluble resin (A) according to the invention comprises a first alkali-soluble resin (A-1) represented by Formula (1):

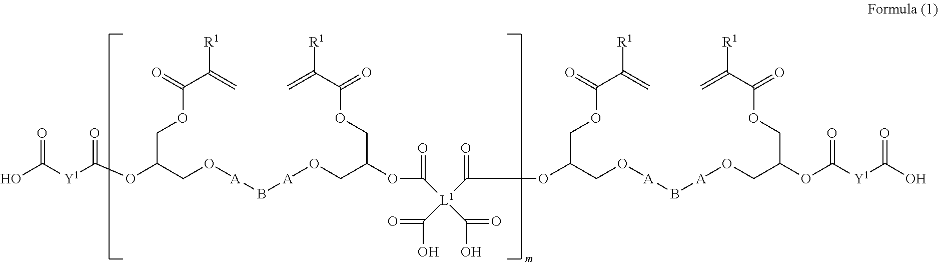

in Formula (1):

A represents a phenylene group or a phenylene group having a substituent, wherein the substituent is a C₁-C₅ alkyl group, a halogen atom, or a phenyl group;

B represents —CO—, —SO₂—, —C(CF₃)₂—, —Si(CH₃)₂—, —CH₂—, —C(CH₃)₂—, —O—, 9,9-fluorenylidene or a single bond;

L¹ represents a tetravalent carboxylic acid residue containing a fluorine atom or a tetravalent carboxylic acid residue without a fluorine atom;

Y¹ represents a divalent carboxylic acid residue containing a fluorine atom or a divalent carboxylic acid residue without a fluorine atom;

R¹ represents a hydrogen atom or a methyl group; and

m represents an integer of 1 to 20;

wherein at least one of L¹ and Y¹ contains the fluorine atom.

It should be mentioned that, L¹ can be a tetravalent carboxylic acid residue containing a fluorine atom or a tetravalent carboxylic acid residue without a fluorine atom, and is preferably a tetravalent aromatic group having fluorine, more preferably a benzene ring having fluorine.

Specifically, the alkali-soluble resin (A-1) is obtained by reacting a first mixture. The first mixture includes a diol compound (a-1) containing a polymeric unsaturated group, a tetracarboxylic acid (a-2) or an acid dianhydride thereof, and a dicarboxylic acid (a-3) or an acid anhydride thereof. At least one of the tetracarboxylic acid (a-2) or the acid dianhydride thereof and the dicarboxylic acid (a-3) or the acid anhydride thereof contains the fluorine atom. Each component of the first mixture is described below.

The diol compound (a-1) containing the polymeric unsaturated group is obtained by reacting a bisphenol compound (a-1-i) having two epoxy groups and a compound (a-1-ii) having at least one carboxylic acid group and at least one ethylenically unsaturated group. The reactants used to synthesize the diol compound (a-1) containing the polymeric unsaturated group can also contain other compounds.

The bisphenol compound (a-1-i) having two epoxy groups can, for instance, be obtained by reacting a bisphenol compound and an epihalohydrin in a dehydrohalogenation reaction under the existence of an alkali metal hydroxide.

Specific examples of the bisphenol used to synthesize the bisphenol compound (a-1-i) having two epoxy groups include bis(4-hydroxyphenyl)ketone, bis(4-hydroxy-3,5-dimethylphenyl)ketone, bis(4-hydroxy-3,5-dichlorophenyl)ketone, bis(4-hydroxyphenyl)sulfone, bis(4-hydroxy-3,5-dimethylphenyl)sulfone, bis(4-hydroxy-3,5-dichlorophenyl)sulfone, bis(4-hydroxyphenyl)hexafluoropropane, bis(4-hydroxy-3,5-dimethylphenyl)hexafluoropropane, bis(4-hydroxy-3,5-dichlorophenyl)hexafluoropropane, bis(4-hydroxyphenyl)dimethylsilane, bis(4-hydroxy-3,5-dimethylphenyl)dimethylsilane, bis(4-hydroxy-3,5-dichlorophenyl)dimethylsilane, bis(4-hydroxyphenyl)methane, bis(4-hydroxy-3,5-dichlorophenyl)methane, bis(4-hydroxy-3,5-dibromophenyl)methane, 2,2-bis(4-hydroxyphenyl)propane, 2,2-bis(4-hydroxy-3,5-dimethylphenyl)propane, 2,2-bis(4-hydroxy-3,5-dichlorophenyl)propane, 2,2-bis(4-hydroxy-3-methylphenyl)propane, 2,2-bis(4-hydroxy-3-chlorophenyl)propane, bis(4-hydroxyphenyl)ether, bis(4-hydroxy-3,5-dimethylphenyl)ether, or bis(4-hydroxy-3,5-dichlorophenyl)ether; 9,9-bis(4-hydroxyphenyl)fluorene, 9,9-bis(4-hydroxy-3-dimethylphenyl)fluorene, 9,9-bis(4-hydroxy-3-chlorophenyl)fluorene, 9,9-bis(4-hydroxy-3-bromophenyl)fluorene, 9,9-bis(4-hydroxy-3-fluorophenyl)fluorene, 9,9-bis(4-hydroxy-3,5-dimethylphenyl)fluorene, or a combination of the compounds.

Specific examples of the epihalohydrin used to synthesize the bisphenol compound (a-1-i) having two epoxy groups include 3-chloro-1,2-epoxypropane, 3-bromo-1,2-epoxypropane, or a combination of the compounds. Based on a total equivalent of the hydroxyl group in the bisphenol compound as 1 equivalent, the used amount of the epihalohydrin can be 1 equivalent to 20 equivalents, preferably 2 equivalents to 10 equivalents.

Specific examples of the alkali metal hydroxide include sodium hydroxide, potassium hydroxide, or a combination of the compounds. Based on a total equivalent of the hydroxyl group in the bisphenol compound as 1 equivalent, the used amount of the alkali metal hydroxide added in the dehydrohalogenation reaction can be 0.8 equivalents to 15 equivalents, preferably 0.9 equivalents to 11 equivalents.

It should be mentioned that, before the dehydrohalogenation reaction is performed, the alkali metal hydroxide such as sodium hydroxide or potassium hydroxide can be pre-added or added during the reaction process. The operating temperature of the dehydrohalogenation reaction is 20° C. to 120° C. and the operating duration thereof ranges from 1 hour to 10 hours.

In an embodiment, the alkali metal hydroxide added to the dehydrohalogenation reaction can also be an aqueous solution thereof. In the present embodiment, when an aqueous solution of the alkali metal hydroxide is continuously added in the dehydrohalogenation reaction system, water and epihalohydrin can be continuously distilled under reduced pressure or atmospheric pressure to separate and remove water, and epihalohydrin can be continuously flown back to the reaction system, simultaneously.

Before the dehydrohalogenation reaction is performed, a quaternary ammonium salt such as tetramethyl ammonium chloride, tetramethyl ammonium bromide, or trimethylbenzyl ammonium chloride can also be added as a catalyst. Then, at 50° C. to 150° C., the mixture is reacted for 1 hour to 5 hours, and then the alkali metal hydroxide or the aqueous solution thereof is added. Then, the mixture is reacted at a temperature of 20° C. to 120° C. for 1 hour to 10 hours to perform the dehydrohalogenation reaction.

Moreover, to facilitate the dehydrohalogenation reaction, in addition to an alcohol such as methanol or ethanol, an aprotic polar solvent such as dimethyl sulfone or dimethyl sulfoxide can also be added to perform the reaction. When the alcohol is used, based on a total amount of 100 wt % of the epihalohydrin, the used amount of the alcohol can be 2 wt % to 20 wt %, preferably 4 wt % to 15 wt %. When the aprotic polar solvent is used, based on a total amount of 100 wt % of the epihalohydrin, the used amount of the aprotic polar solvent can be 5 wt % to 100 wt %, preferably 10 wt % to 90 wt %.

After the dehydrohalogenation reaction is complete, a rinse treatment can be optionally performed. Then, the epihalohydrin, the alcohol, the aprotic polar solvent and so on are removed by using a method of heating under reduced pressure, such as at a temperature of 110° C. to 250° C. and a pressure of 1.3 kPa (10 mmHg).

To prevent the epoxy resin formed from containing a hydrolyzable halogen, the solution after the dehydrohalogenation reaction can be added to a solvent such as benzene, toluene, or methyl isobutyl ketone, and then the aqueous solution of the alkali metal hydroxide such as sodium hydroxide or potassium hydroxide can be added to perform the dehydrohalogenation reaction again. In the dehydrohalogenation reaction, based on a total equivalent of the hydroxyl group in the bisphenol compound as 1 equivalent, the used amount of the alkali metal hydroxide can be 0.01 moles to 1 mole, preferably 0.05 moles to 0.9 moles. Moreover, the operating temperature of the dehydrohalogenation reaction ranges from 50° C. to 120° C. and the operating duration thereof ranges from 0.5 hours to 2 hours.

After the dehydrohalogenation reaction is complete, salts are removed through steps such as filtering and rinsing. Moreover, solvents such as benzene, toluene, and methyl isobutyl ketone can be distilled by a method of heating under reduced pressure to obtain the bisphenol compound (a-1-i) having two epoxy groups.

The bisphenol compound (a-1-i) having two epoxy groups is preferably a bisphenol compound having two epoxy groups represented by Formula (1-1) or a polymer formed by polymerizing a bisphenol compound having two epoxy groups represented by Formula (1-2) as a monomer:

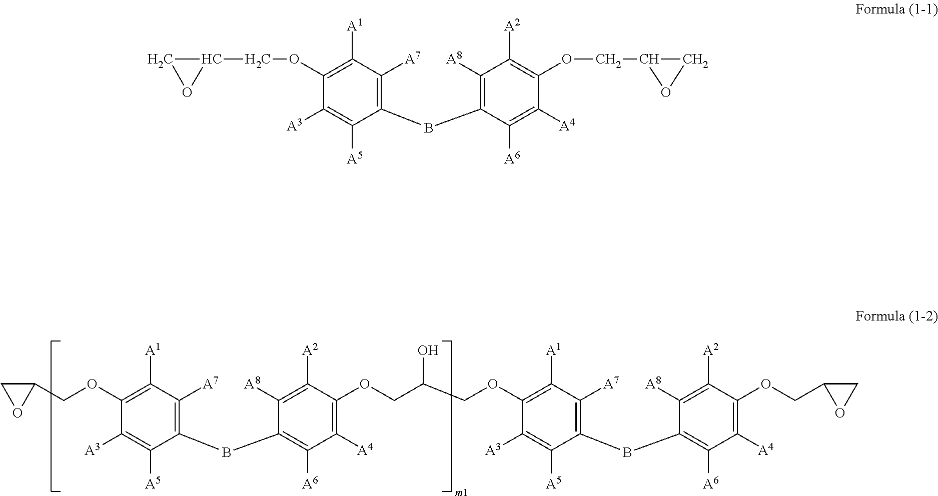

in Formula (1-1) and Formula (1-2), A¹ to A⁸ each independently represent a hydrogen atom, a halogen atom, a C₁ to C₅ alkyl group or a phenyl group; B represents —CO—, —SO₂—, —C(CF₃)₂—, —Si(CH₃)₂—, —CH₂—, —C(CH₃)₂—, —O—, 9,9-fluorenylidene or a single bond; and ml can represent an integer of 1 to 10, and ml preferably represents an integer of 1 to 2.

The bisphenol compound having two epoxy groups represented by Formula (1-1) is preferably a bisphenol compound having two epoxy groups represented by Formula (1-3).

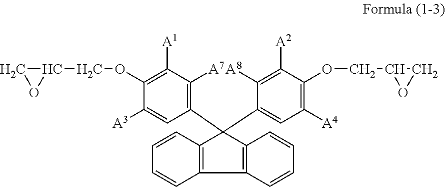

in Formula (1-3), A¹, A², A³, A⁴, A⁷, and A⁸ each independently represent a hydrogen atom, a halogen atom, a C₁ to C₅ alkyl group, or a phenyl group.

The bisphenol compound having two epoxy groups represented by Formula (1-3) is, for instance, a bisphenol fluorene-type compound having two epoxy groups obtained by reacting a bisphenol fluorene compound and an epihalohydrin.

Specific examples of the bisphenol fluorene-type compound include 9,9-bis(4-hydroxyphenyl)fluorene, 9,9-bis(4-hydroxy-3-methylphenyl)fluorene, 9,9-bis(4-hydroxy-3-chlorophenyl)fluorene, 9,9-bis(4-hydroxy-3-bromophenyl)fluorene, 9,9-bis(4-hydroxy-3-fluorophenyl)fluorene, 9,9-bis(4-hydroxy-3-methoxyphenyl)fluorene, 9,9-bis(4-hydroxy-3,5-dimethylphenyl)fluorene, 9,9-bis(4-hydroxy-3,5-dichlorophenyl)fluorene, 9,9-bis(4-hydroxy-3,5-dibromophenyl)fluorene or a combination of the compounds.

Specific examples of epihalohydrin include epichlorohydrin, epibromohydrin or a combination of the compounds.

Specific examples of the bisphenol fluorene-type compound having the epoxy group include (1) a product made by Nippon Steel Chemical such as ESF-300 or a similar compound thereof; (2) a product made by Osaka Gas such as PG-100, EG-210, or a similar compound thereof; and (3) a product made by S.M.S. Technology Co. such as SMS-F9PhPG, SMS-F9CrG, SMS-F914PG, or a similar compound thereof.

The compound (a-1-ii) having at least one carboxylic acid group and at least one ethylenically unsaturated group is at least one compound selected from the group consisting of the following compounds: acrylic acid, methacrylic acid, 2-methacryloyloxyethylbutanedioic acid, 2-methacryloyloxybutylbutanedioic acid, 2-methacryloyloxyethylhexanedioic acid, 2-methacryloyloxybutylhexanedioic acid, 2-methacryloyloxyethylhexahydrophthalic acid, 2-methacryloyloxyethylmaleic acid, 2-methacryloyloxypropylmaleic acid, 2-methacryloyloxybutylmaleic acid, 2-methacryloyloxypropylbutanedioic acid, 2-methacryloyloxypropylhexanedioic acid, 2-methacryloyloxypropyltetrahydrophthalic acid, 2-methacryloyloxypropylphthalic acid, 2-methacryloyloxybutylphthalic acid or 2-methacryloyloxybutylhydrophthalic acid; a compound obtained by reacting (meth)acrylate containing a hydroxyl group and a dicarboxylic acid compound, wherein the dicarboxylic acid compound contains, but is not limited to, adipic acid, succinic acid, maleic acid, or phthalic acid; and a hemiester compound obtained by reacting (meth)acrylate containing a hydroxyl group and a carboxylic acid anhydride compound, wherein the (meth)acrylate containing a hydroxyl group contains, but is not limited to, (2-hydroxyethyl) acrylate, (2-hydroxyethyl) methacrylate, (2-hydroxypropyl) acrylate, (2-hydroxypropyl) methacrylate, (4-hydroxybutyl) acrylate, (4-hydroxybutyl) methacrylate or pentaerythritol trimethacrylate. Moreover, specific examples of the carboxylic acid anhydride compound can be the same as the specific examples of the tetracarboxylic acid dianhydride in an other tetracarboxylic acid (a-2-2) or an acid dianhydride thereof below and the specific examples of the dicarboxylic acid anhydride in an other dicarboxylic acid (a-3-2) or an acid anhydride thereof below, and are therefore not repeated herein.

The tetracarboxylic acid (a-2) or the acid dianhydride thereof includes a tetracarboxylic acid (a-2-1) or an acid dianhydride thereof containing a fluorine atom, an other tetracarboxylic acid (a-2-2) or an acid dianhydride thereof other than the tetracarboxylic acid (a-2-1) or the acid dianhydride thereof containing the fluorine atom, or a combination of the two.

The tetracarboxylic acid (a-2-1) or the acid dianhydride thereof containing the fluorine atom is selected from the group consisting of a tetracarboxylic acid compound containing a fluorine atom represented by Formula (2-1) and a tetracarboxylic acid dianhydride compound containing a fluorine atom represented by Formula (2-2). Specifically, the tetracarboxylic acid compound containing the fluorine atom represented by Formula (2-1) and the tetracarboxylic acid dianhydride compound containing the fluorine atom represented by Formula (2-2) are as shown below.

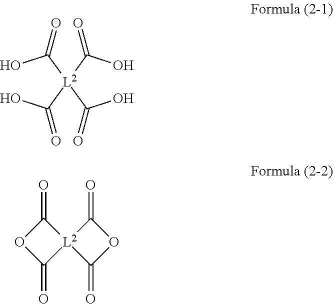

in Formula (2-1) and Formula (2-2), L² is a tetravalent aromatic group having fluorine and preferably has a benzene ring. Specifically, one of the groups represented by Formulae (L-1) to (L-6) is preferred.

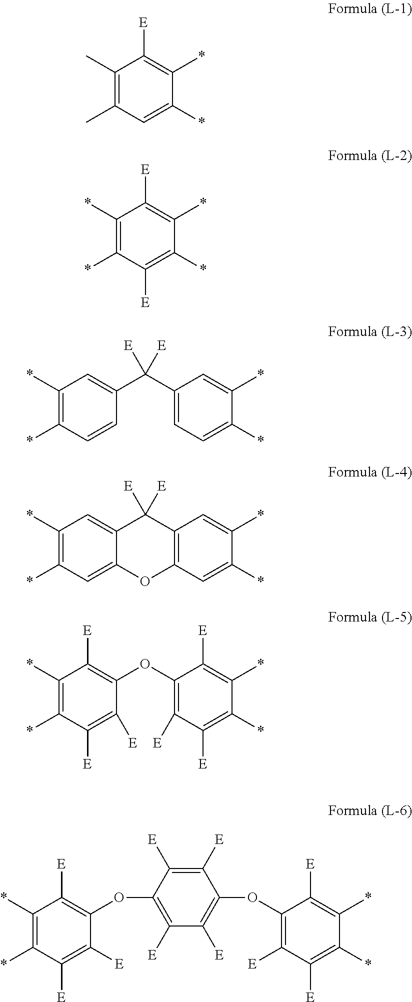

in Formula (L-1) to Formula (L-6), E independently represents a fluorine atom or a trifluoromethyl group, and * represents a binding position with a carbon atom.

In detail, specific examples of the tetracarboxylic acid (a-2-1) or the acid dianhydride thereof containing the fluorine atom include an aromatic tetracarboxylic acid containing fluorine such as 4,4′-hexafluoro isopropylidene diphthalic acid, 1,4-difluoropyromellitic acid, 1-monofluoropyromellitic acid, 1,4-ditrifluoromethylpyromellitic acid, a dianhydride compound of the above tetracarboxylic acids or a combination of the compounds.

Specific examples of the tetracarboxylic acid (a-2-1) or the acid dianhydride thereof containing the fluorine atom further include a tetracarboxylic acid containing fluorine such as 3,3′-(hexafluoro isopropylidene) diphthalic acid, 5,5′-[2,2,2-trifluoro-1-[3-(trifluoromethyl) phenyl] ethylidene] diphthalic acid, 5,5′-[2,2,3,3,3-pentafluoro-1-(trifluoromethyl) propylidene] diphthalic acid, 5,5′-oxybis[4,6,7-trifluoro-pyromellitic acid], 3,6-bis(trifluoromethyl)pyromellitic acid, 4-(trifluoromethyl) pyromellitic acid, 1,4-bis(3,4-dicarboxylic acid trifluorophenoxy)tetrafluoro benzene, a dianhydride compound of the above tetracarboxylic acids or a combination of the compounds.

The other tetracarboxylic acids (a-2-2) or the acid dianhydride thereof include a saturated straight-chain hydrocarbon tetracarboxylic acid, an alicyclic tetracarboxylic acid, an aromatic tetracarboxylic acid, a dianhydride compound of the above tetracarboxylic acids, or a combination thereof.

Specific examples of the saturated straight-chain hydrocarbon tetracarboxylic acid include butanetetracarboxylic acid, pentanetetracarboxylic acid, hexanetetracarboxylic acid or a combination of the compounds. The saturated straight-chain hydrocarbon tetracarboxylic acid can also have a substituent.

Specific examples of the alicyclic tetracarboxylic acid include cyclobutanetetracarboxylic acid, cyclopentanetetracarboxylic acid, cyclohexanetetracarboxylic acid, norbornane tetracarboxylic acid or a combination of the compounds. The alicyclic tetracarboxylic acid can also have a substituent.

Specific examples of the aromatic tetracarboxylic acid include pyromellitic acid, benzophenone tetracarboxylic acid, biphenyl tetracarboxylic acid, biphenylether tetracarboxylic acid, diphenylsulfone tetracarboxylic acid, 1,2,3,6-tetrahydrophthalic acid or a combination of the compounds. The aromatic tetracarboxylic acid can also have a substituent.

The dicarboxylic acid (a-3) or the acid anhydride thereof includes a dicarboxylic acid (a-3-1) or an acid anhydride thereof containing a fluorine atom, an other dicarboxylic acid (a-3-2) or an acid anhydride thereof other than the dicarboxylic acid (a-3-1) or the acid anhydride thereof containing the fluorine atom or a combination of the two.

The dicarboxylic acid (a-3-1) or the acid anhydride thereof containing the fluorine atom is selected from the group consisting of a dicarboxylic acid compound containing a fluorine atom represented by Formula (3-1) and a dicarboxylic acid anhydride compound containing a fluorine atom represented by Formula (3-2). Specifically, the dicarboxylic acid compound containing a fluorine atom represented by Formula (3-1) and the dicarboxylic acid anhydride compound containing a fluorine atom represented by Formula (3-2) are as shown below.

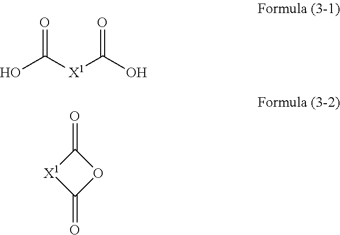

in Formula (3-1) and Formula (3-2), X¹ represents a C₁ to C₁₀₀ organic group containing a fluorine atom.

Specific examples of the dicarboxylic acid (a-3-1) or the acid anhydride thereof containing the fluorine atom include 3-fluorophthalic acid, 4-fluorophthalic acid, tetrafluorophthalic acid, 3,6-difluorophthalic acid, tetrafluoro succinic acid, an acid anhydride compound of the above dicarboxylic acids or a combination of the compounds.

Specific examples of the other dicarboxylic acid (a-3-2) or the acid anhydride thereof include a saturated straight-chain hydrocarbon dicarboxylic acid, a saturated cyclic hydrocarbon dicarboxylic acid, an unsaturated dicarboxylic acid, an acid anhydride of the above dicarboxylic acid compounds or a combination of the compounds.

Specific examples of the saturated straight-chain hydrocarbon dicarboxylic acid include succinic acid, acetyl succinic acid, adipic acid, azelaic acid, citramalic acid, malonic acid, glutaric acid, citric acid, tataric acid, ketogluconic acid, pimelic acid, sebacic acid, suberic acid, diglycolic acid or a combination of the compounds. The hydrocarbon group in the saturated straight-chain hydrocarbon dicarboxylic acid can also be substituted.

Specific examples of the saturated cyclic hydrocarbon dicarboxylic acid include hexahydrophthalic acid, cyclobutanedicarboxylic acid, cyclopentanedicarboxylic acid, norbornanedicarboxylic acid, hexahydrotrimellitic acid, or a combination of the compounds. The saturated cyclic hydrocarbon dicarboxylic acid can also be an alicyclic dicarboxylic acid in which a saturated hydrocarbon is substituted.

Specific examples of the unsaturated dicarboxylic acid include maleic acid, itaconic acid, phthalic acid, tetrahydrophthalic acid, methyl endo-methylene tetrahydro phthalic acid, chlorendic acid, trimellitic acid or a combination of the compounds.

Specific examples of the other dicarboxylic acid (a-3-2) or the acid anhydride thereof include a dicarboxylic acid anhydride such as trimethoxysilylpropyl succinic anhydride, triethoxysilylpropyl succinic anhydride, methyldimethoxysilylpropyl succinic anhydride, methyldiethoxysilylpropyl succinic anhydride, trimethoxysilylbutyl succinic anhydride, triethoxysilylbutyl succinic anhydride, methyldiethoxysilylbutyl succinic anhydride, para-(trimethoxysilyl)phenyl succinic anhydride, para-(triethoxysilyl)phenyl succinic anhydride, para-(methyldimethoxysilyl)phenyl succinic anhydride, para-(methyldiethoxysilyl)phenyl succinic anhydride, meta-(trimethoxysilyl)phenyl succinic anhydride, meta-(triethoxysilyl)phenyl succinic anhydride, meta-(methyldiethoxysilyl)phenyl succinic anhydride, a dicarboxylic acid compound of the above dicarboxylic acid anhydrides or a combination of the compounds.

The dicarboxylic acid compound is preferably succinic acid, itaconic acid, tetrahydrophthalic acid, hexahydrotrimellitic acid, phthalic acid, trimellitic acid or a combination of the compounds, and is more preferably succinic acid, itaconic acid, tetrahydrophthalic acid or a combination of the compounds.

The dicarboxylic acid anhydride is preferably butanedioic anhydride, itaconic anhydride, tetrahydrophthalic anhydride, hexahydrotrimellitic anhydride, phthalic anhydride, trimellitic anhydride or a combination of the compounds.

The method for synthesizing the alkali-soluble resin (A-1) is not particularly limited, and the alkali-soluble resin (A-1) can be obtained as long as the diol compound (a-1) containing the polymeric unsaturated group, the tetracarboxylic acid dianhydride (a-2) or the tetracarboxylic acid thereof, and the dicarboxylic acid anhydride (a-3) or the dicarboxylic acid thereof are reacted.

When preparing the alkali-soluble resin (A-1), to speed up the reaction, an alkali compound is generally added in the reaction solution as a reaction catalyst. Specific examples of the reaction catalyst include triphenyl phosphine, triphenyl stibine, triethylamine, triethanolamine, tetramethylammonium chloride, benzyltriethylammonium chloride, or a combination of the reaction catalysts. The reaction catalyst can be used alone or in a combination of two or more.

Moreover, to control the degree of polymerization, an inhibitor is generally added in the reaction solution. Specific examples of the inhibitor include methoxyphenol, methylhydroquinone, hydroquinone, 2,6-di-tert-butyl-p-cresol, phenothiazine, or a similar compound thereof. The inhibitor can be used alone or in a combination of two or more.

When preparing the alkali-soluble resin (A-1), a polymerization solvent can be used when needed. Specific examples of the polymerization solvent include: an alcohol compound such as ethanol, propanol, isopropanol, butanol, isobutanol, 2-butanol, hexanol, ethylene glycol, or a similar compound thereof; a ketone compound such as methyl ethyl ketone, cyclohexanone, or a similar compound thereof; an aromatic hydrocarbon compound such as toluene, xylene, or a similar compound thereof; a cellosolve compound such as cellosolve, butyl cellosolve, or a similar compound thereof; a carbitol compound such as carbitol, butyl carbitol, or a similar compound thereof; a propylene glycol alkyl ether compound such as propylene glycol monomethyl ether or a similar compound thereof; a poly(propylene glycol) alkyl ether compound such as di(propylene glycol) methyl ether or a similar compound thereof; an acetate compound such as ethyl acetate, butyl acetate, ethylene glycol monoethyl ether acetate, propylene glycol methyl ether acetate, propylene glycol methyl monoether acetate, or a similar compound thereof; an alkyl lactate compound such as ethyl lactate, butyl lactate, or a similar compound thereof; a dialkyl glycol ether; or other esters such as methyl 2-hydroxy-2-methylpropionate, ethyl 2-hydroxy-2-methylpropionate, methyl 3-methoxypropionate, ethyl 3-methoxypropionate, methyl 3-ethoxypropionate, ethyl 3-ethoxypropionate (EEP), and ethyl ethoxyacetate. The polymerization solvent can be used alone or in a combination of two or more. Moreover, the acid value of the alkali-soluble resin (A-1) is 50 mgKOH/g to 200 mgKOH/g, preferably 60 mgKOH/g to 180 mgKOH/g.

Moreover, the synthesis method can include a known method for reacting a diol compound and tetracarboxylic acid dianhydride at a reaction temperature of 90° C. to 140° C. as described in Japanese Patent Publication No. 9-325494. Moreover, the first mixture is uniformly dissolved and reacted at a reaction temperature of 90° C. to 130° C. and then reacted and aged at a reaction temperature of 40° C. to 80° C.

The alkali-soluble resin (A-1) obtained by reacting the first mixture is an alkali-soluble resin containing a fluorene atom, and is preferably an alkali-soluble resin containing an aromatic structure having fluorine.

Moreover, in the first mixture for forming the alkali-soluble resin (A-1), at least one of the tetracarboxylic acid (a-2) or the acid dianhydride thereof and the dicarboxylic acid (a-3) or the acid anhydride thereof contains a fluorine atom, and preferably both the tetracarboxylic acid (a-2) or the acid dianhydride thereof and the dicarboxylic acid (a-3) or the acid anhydride thereof contain the fluorine atom. If the tetracarboxylic acid (a-2) or the acid dianhydride thereof or the dicarboxylic acid (a-3) or the acid anhydride thereof does not contain the fluorine atom, the resolution of the photosensitive resin composition is poor. Specifically, when both the tetracarboxylic acid (a-2) or the acid dianhydride thereof and the dicarboxylic acid (a-3) or the acid anhydride thereof contain the fluorine atom, the tetracarboxylic acid (a-2) or the acid dianhydride thereof includes the tetracarboxylic acid (a-2-1) or the acid dianhydride thereof containing the fluorine atom, and the dicarboxylic acid (a-3) or the acid anhydride thereof includes the dicarboxylic acid (a-3-1) or the acid anhydride thereof containing the fluorine atom.

Since the fluorine atom can effectively increase the alkali resistance of the alkali-soluble resin (A), the development resistance of the photosensitive resin composition is better. Moreover, due to the development resistance of the photosensitive resin composition, a finer pattern can remain on a substrate during development, thereby increasing the resolution of the photosensitive resin composition.

Moreover, if the molar number of the diol compound (a-1) containing the polymeric unsaturated group, the molar number of the tetracarboxylic acid (a-2-1) or the acid dianhydride thereof containing the fluorine atom, and the molar number of the dicarboxylic acid (a-3-1) or the acid anhydride thereof containing the fluorine atom satisfy the equation of [(a-2-1)+(a-3-1)]/(a-1)=0.4 to 1.6, the resolution of the photosensitive resin composition can be further improved.

Based on 100 parts by weight of the used amount of the alkali-soluble resin (A), the used amount of the first alkali-soluble resin (A-1) is from 20 parts by weight to 100 parts by weight, preferably 25 parts by weight to 90 parts by weight, and more preferably 30 parts by weight to 80 parts by weight. When the first alkali-soluble resin (A-1) is absent, the resolution and the taper angle of the photosensitive resin composition are poor.

The alkali-soluble resin according to the invention can optionally further comprise a second alkali-soluble resin (A-2) and an other alkali-soluble resin (A-3).

The second alkali-soluble resin (A-2) includes a derived unit having a structure represented by Formula (4):

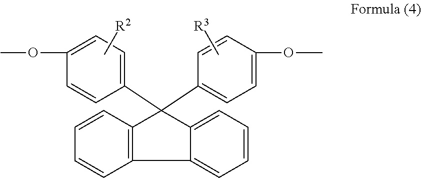

in Formula (4), R² and R³ each independently represent a hydrogen atom, a C₁ to C₅ straight-chain or branch-chain alkyl group, a phenyl group or a halogen atom.

The second alkai-soluble resin (A-2) is obtained by reacting a compound having the structure represented by Formula (4) and an other copolymerizable compound. The compound having the structure represented by Formula (4) can be a bisphenol fluorene-type compound containing two epoxy groups represented by Formula (5) or a bisphenol fluorene-type compound containing two hydroxyl groups represented by Formula (6).

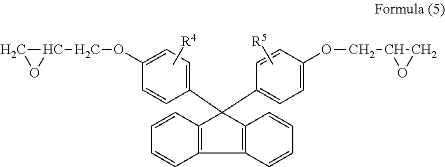

in Formula (5), R⁴ is the same as R² in Formula (4); and R⁵ is the same as

R³ in Formula (4).

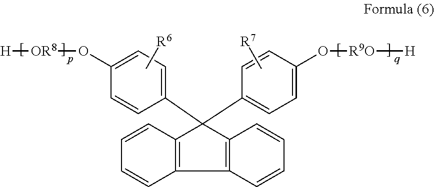

in Formula (6), R⁶ is the same as R² in Formula (4); R⁷ is the same as R³ in Formula (4); R⁸ and R⁹ each independently represent a C₁ to C₂₀ alkylene group or alicyclic group; and p and q each independently represent an integer of 1 to 4.

Specific examples of the other copolymerizable compound include an unsaturated monocarboxylic acid such as acrylic acid, methacrylic acid, butenoic acid, α-chloroacrylic acid, ethyl acrylic acid or cinnamic acid; a dicarboxylic acid such as maleic acid, itaconic acid, succinic acid, phthalic acid, tetrahydrophthalic acid, hexahydrophthalic acid, methyl tetrahydrophthalic acid, methyl hexahydrophthalic acid, methyl endo-methylene tetrahydro phthalic acid, chlorendic acid, or glutaric acid, and an acid anhydride thereof; a tricarboxylic acid such as trimellitic acid and an acid anhydride thereof; and a tetracarboxylic acid such as pyromellitic acid, benzophenone tetracarboxylic acid, biphenyl tetracarboxylic acid, or biphenylether tetracarboxylic acid, an acid anhydride thereof, or a combination of the compounds.

The second alkai-soluble resin (A-2) is preferably a product manufactured by Nippon Steel Chemical such as V259ME or V301ME.

Based on 100 parts by weight of the used amount of the alkali-soluble resin (A), the used amount of the second alkali-soluble resin (A-2) is from 0 parts by weight to 80 parts by weight, preferably 10 parts by weight to 75 parts by weight, and more preferably 20 parts by weight to 70 parts by weight.

The other alkali-soluble resin (A-3) is a resin other than the first alkali-soluble resin (A-1) and the second alkali-soluble resin (A-2). The other alkali-soluble resin (A-3) is, for instance, a resin having a carboxylic acid group or a hydroxyl group, but is not limited to the resin having the carboxylic acid group or the hydroxyl group. Specific examples of the other alkai-soluble resin (A-3) include a resin such as acrylic resin, urethane resin, or novolac resin.

Based on 100 parts by weight of the used amount of the alkali-soluble resin (A), the used amount of the other alkali-soluble resin (A-3) is 0 parts by weight to 30 parts by weight, preferably 0 parts by weight to 20 parts by weight, and more preferably 0 parts by weight to 10 parts by weight.

The photosensitive resin composition according to the invention comprises the compound (B) containing the ethylenically unsaturated group.

The compound (B) containing the ethylenically unsaturated group can be selected from a compound having one ethylenically unsaturated group or a compound having at least two (including two) ethylenically unsaturated groups.

Specific examples of the compound having one ethylenically unsaturated group include (meth)acrylamide, (meth)acryloylmorpholine, 7-amino-3,7-dimethyloctyl (meth)acrylate, isobutoxymethyl(meth)acrylamide, isobornyloxyethyl (meth)acrylate, isobornyl (meth)acrylate, 2-ethylhexyl (meth)acrylate, ethyl diethylene glycol (meth)acrylate, t-octyl(meth)acrylamide, diacetone(meth)acrylamide, dimethylaminoethyl (meth)acrylate, dodecyl (meth)acrylate, dicyclopentenyloxyethyl (meth)acrylate, dicyclopentenyl (meth)acrylate, N,N-dimethyl(meth)acrylamide, tetrachlorophenyl (meth)acrylate, 2-tetrachlorophenoxy ethyl (meth)acrylate, tetrahydrofurfuryl (meth)acrylate, tetrabromophenyl (meth)acrylate, 2-tetrabromophenoxyethyl (meth)acrylate, 2-trichlorophenoxyethyl (meth)acrylate, tribromophenyl (meth)acrylate, 2-tribromophenoxyethyl (meth)acrylate, ethyl 2-hydroxy-(meth)acrylate, propyl 2-hydroxy-(meth)acrylate, vinylcaprolactam, N-vinylpyrrolidone, phenoxyethyl (meth)acrylate, pentachlorophenyl(meth)acrylate, pentabromophenyl (meth)acrylate, polyethylene glycol mono(meth)acrylate, polypropylene glycol mono(meth)acrylate and bornyl (meth)acrylate. The compound having one ethylenically unsaturated group can be used alone or in a combination of two or more.

Specific examples of the compound having at least two (including two) ethylenically unsaturated groups include ethylene glycol di(meth)acrylate, dicyclopentenyl di(meth)acrylate, triethylene glycol di(meth)acrylate, tetraethylene glycol di(meth)acrylate, tri(2-hydroxyethyl) isocyanurate di(meth)acrylate, tri(2-hydroxyethyl) isocyanurate tri(meth)acrylate, caprolactone-modified tri(2-hydroxyethyl) isocyanurate tri(meth)acrylate, trimethylolpropyl tri(meth)acrylate, ethylene oxide (EO) modified trimethylolpropyl tri(meth)acrylate, propylene oxide (PO) modified trimethylolpropyl tri(meth)acrylate, tripropylene glycol di(meth)acrylate, neo-pentyl glycol di(meth)acrylate, 1,4-butanediol di(meth)acrylate, 1,6-hexanediol di(meth)acrylate, pentaerythritol tri(meth)acrylate, pentaerythritol tetra(meth)acrylate, polyester di(meth)acrylate, polyethylene glycol di(meth)acrylate, dipentaerythritol hexa(meth)acrylate, dipentaerythritol penta(meth)acrylate, dipentaerythritol tetra(meth)acrylate, caprolactone-modified dipentaerythritol hexa(meth)acrylate, caprolactone-modified dipentaerythritol penta(meth)acrylate, di(trimethylolpropane) tetra(meth)acrylate, EO-modified bisphenol A di(meth)acrylate, PO-modified bisphenol A di(meth)acrylate, EO-modified hydrogenated bisphenol A di(meth)acrylate, PO-modified hydrogenated bisphenol A di(meth)acrylate, PO-modified glycerol triacrylate, EO-modified bisphenol F di(meth)acrylate, novolac polyglycidyl ether (meth)acrylate, a similar compound thereof or a combination of the compounds. The compound having at least two (including two) ethylenically unsaturated groups can be used alone or in a combination of two or more.

Specific examples of the compound (B) containing the ethylenically unsaturated group include trimethylolpropyl triacrylate, EO-modified trimethylolpropyl triacrylate, PO-modified trimethylolpropyl triacrylate, pentaerythritol triacrylate, pentaerythritol tetraacrylate, dipentaerythritol hexaacrylate, dipentaerythritol pentaacrylate, dipentaerythritol tetraacrylate, caprolactone-modified dipentaerythritol hexaacrylate, ditrimethylolpropyl tetraacrylate, PO-modified glycerol triacrylate, a similar compound thereof or a combination of the compounds.

The compound (B) containing the ethylenically unsaturated group is preferably trimethylolpropane triacrylate, dipentaerythritol tetracrylate, dipentaerythritol hexaacrylate or a combination of the compounds.

Based on 100 parts by weight of the used amount of the alkali-soluble resin (A), the used amount of the compound (B) containing the ethylenically unsaturated group is from 20 parts by weight to 180 parts by weight, preferably 25 parts by weight to 160 parts by weight, and more preferably 30 parts by weight to 140 parts by weight.

The photoinitiator (C) according to the invention comprises the α-keto oxime ester compound (C-1) represented by Formula (7).

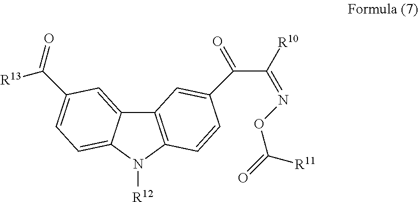

R¹⁰ represents a methylbenzene group having 1 to 5 methyl groups, and specific examples of R¹⁰ include

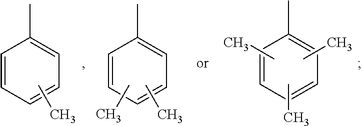

R¹¹ represents a C₁-C₁₀ alkyl group, a benzoyl group, or a C₃-C₆ cycloalkyl group, and preferably, the aforementioned alkyl group is a methyl group; R¹² represents a methyl group, an ethyl group, a propyl group or a benzoyl group, and preferable represents the ethyl group; R¹³ represents —H,

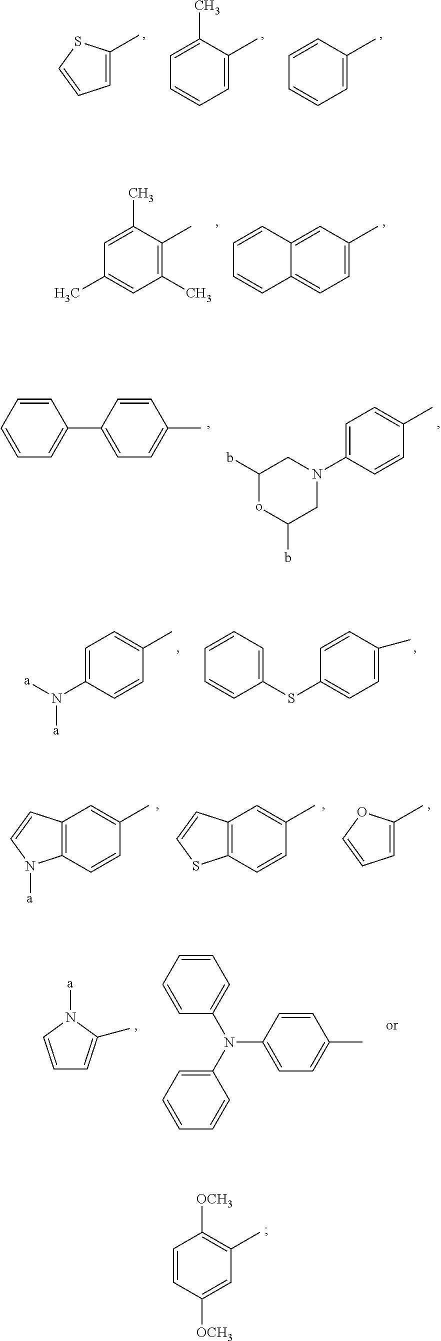

wherein, a represents a methyl group or an ethyl group; and

b represents —H or a methyl group.

In one preferred embodiment of the invention, the α-keto oxime ester compound (C-1) represented by Formula (7) has the structures of Formulae (7-1) to (7-12) as shown below.

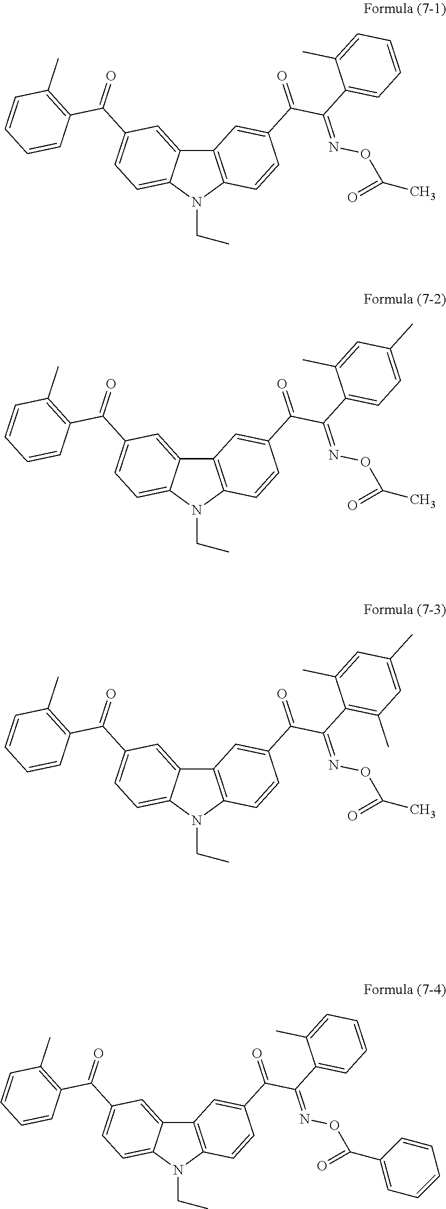 [SMILES: CCn1c2ccc(C(=O)/C(=N/OC(C)=O)c3ccccc3C)cc2c2cc(C(=O)c3ccccc3C)ccc21 ; CCn1c2ccc(C(=O)/C(=N/OC(C)=O)c3ccc(C)cc3C)cc2c2cc(C(=O)c3ccccc3C)ccc21 ; CCn1c2ccc(C(=O)/C(=N/OC(C)=O)c3c(C)cc(C)cc3C)cc2c2cc(C(=O)c3ccccc3C)ccc21 ; CCn1c2ccc(C(=O)/C(=N/OC(=O)c3ccccc3)c3ccccc3C)cc2c2cc(C(=O)c3ccccc3C)ccc21]

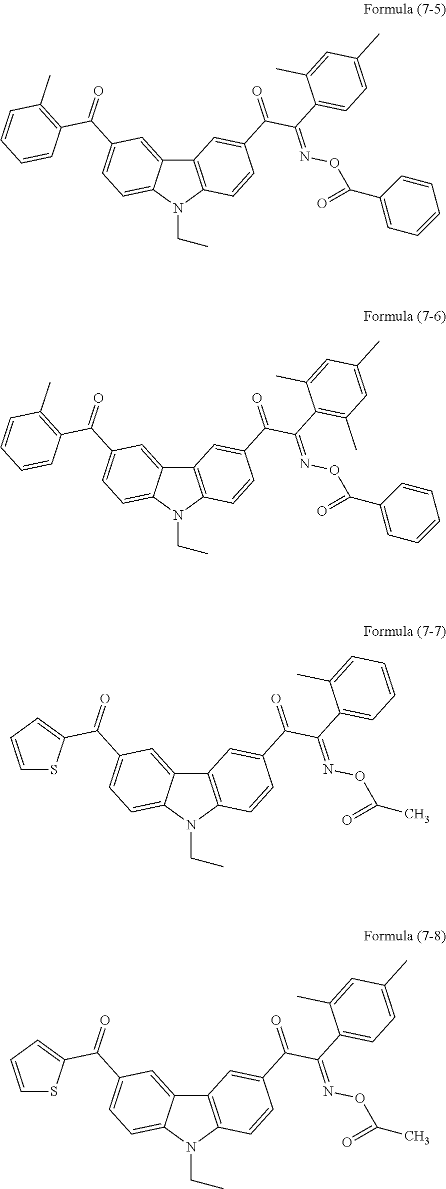 [SMILES: CCn1c2ccc(C(=O)/C(=N/OC(=O)c3ccccc3)c3ccc(C)cc3C)cc2c2cc(C(=O)c3ccccc3C)ccc21 ; CCn1c2ccc(C(=O)/C(=N/OC(=O)c3ccccc3)c3c(C)cc(C)cc3C)cc2c2cc(C(=O)c3ccccc3C)ccc21 ; CCn1c2ccc(C(=O)/C(=N/OC(C)=O)c3ccccc3C)cc2c2cc(C(=O)c3cccs3)ccc21 ; CCn1c2ccc(C(=O)/C(=N/OC(C)=O)c3ccc(C)cc3C)cc2c2cc(C(=O)c3cccs3)ccc21]

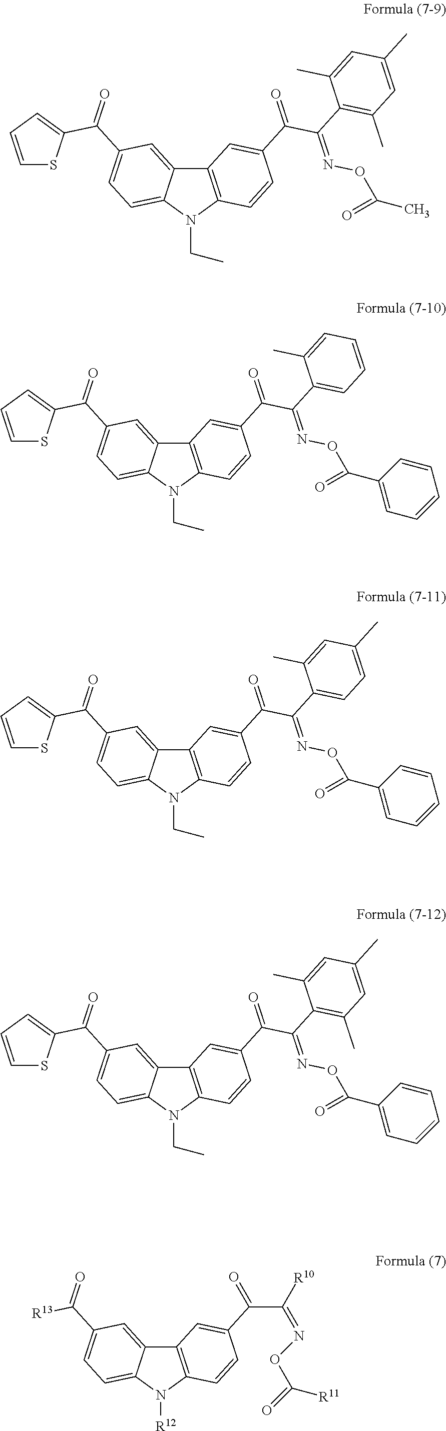

In one embodiment of the invention, the α-keto oxime ester compound (C-1) represented by Formula (7) is obtained by the following reactions: first, a carbazole compound, an acyl chloride compound, and n-methyl phenyl acyl chloride are reacted under the existence of an aluminium chloride in turn, and an acyl compound is obtained. The acyl compound and an isoamyl nitrite are reacted under the existence of a base catalyst, and an α-keto oxime compound is obtained. Next, the α-keto oxime compound and the acyl chloride compound are reacted with a triethylamine catalyst, and the α-keto oxime ester compound represented by Formula (7) is obtained.

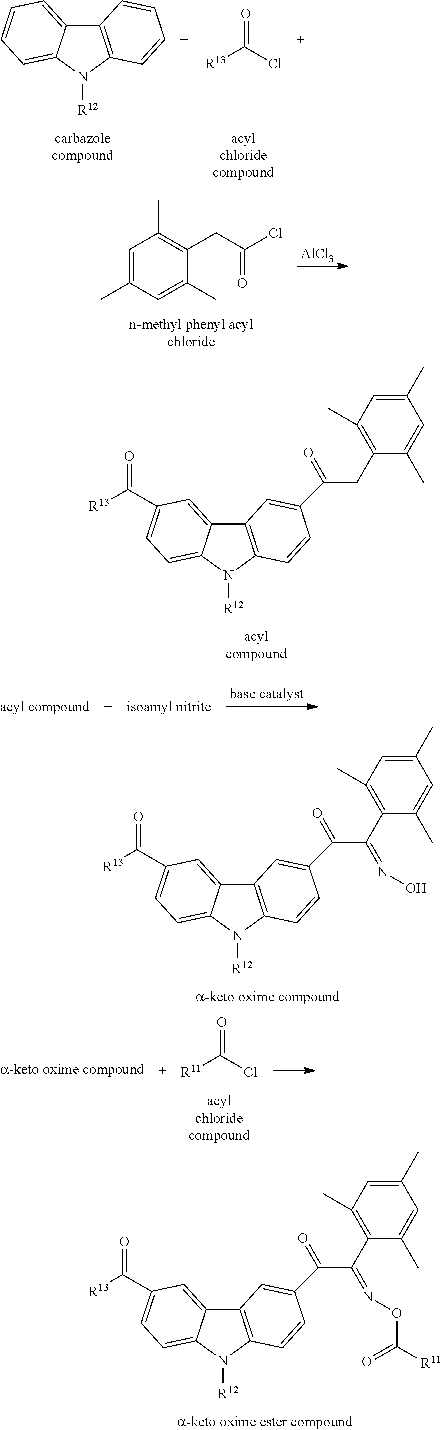

Based on 100 parts by weight of the used amount of the alkali-soluble resin (A), the used amount of the α-keto oxime ester compound (C-1) represented by Formula (7) is from 10 parts by weight to 70 parts by weight, preferably 12 parts by weight to 65 parts by weight, and more preferably 15 parts by weight to 60 parts by weight. When the α-keto oxime ester compound (C-1) represented by Formula (7) is absent, the resolution and the taper angle of the photosensitive resin composition are poor.

In one preferred embodiment of the invention, the photoinitiator (C) according to the invention further comprises a photoinitiator (C-2). In one of specific examples of the invention, the photoinitiator (C-2) includes but not limited to O-acyl oxime compound, triazine compound, acetophenone compound, biimidazole compound, benzophenone compound, α-diketone compound, ketone alcohol compound, ketone alcohol ether compound, acylphosphine oxide compound, quinone compound, halogen-containing compound or peroxide.

Specific examples of the O-acyl oxime compound are 1-[4-(phenylthio)phenyl]-heptane-1,2-dione 2-(O-benzoyloxime), 1-[4-(phenylthio)phenyl]-octane-1,2-dione 2-(O-benzoyloxime) (such as OXE-01 manufactured by Ciba Specialty Chemicals), 1-[4-(benzoyl)phenyl]-octane-1,2-dione 2-(O-benzoyloxime), 1-[9-ethyl-6-(2-methylbenzoyl)-9H-carbazol-3-yl]-ethanone 1-(O-acetyloxime) (such as OXE-02 manufactured by Ciba Specialty Chemicals), 1-[9-ethyl-6-(3-methylbenzoyl)-9H-carbazol-3-yl]-ethanone 1-(OP-acetyloxime), 1-[9-ethyl-6-benzoyl-9H-carbazol-3-yl]-ethanone 1-(O-acetyloxime), ethanone-1-[9-ethyl-6-(2-methyl-4-(tetrahydrofuran)benzoyl)-9H-carbazol-3-yl]-1-(O-acetyloxime), ethanone-1-[9-ethyl-6-(2-methyl-4-(tetrahydropyranyl)benzoyl)-9H-carbazol-3-yl]-1-(O-acetyloxime), ethanone-1-[9-ethyl-6-(2-methyl-5-(tetrahydrofuran) benzoyl)-9H-carbazol-3-yl]-1-(O-acetyloxime), ethanone-1-[9-ethyl-6-(2-methyl-5-(tetrahydropyranyl)benzoyl)-9H-carbazol-3-yl]-1-(O-acetyloxime), ethanone-1-[9-ethyl-6-(2-methyl-4-(tetrahydrofuran)methoxybenzoyl)-9H-carbazol-3-yl]-1-(O-acetyloxime), ethanone-1-[9-ethyl-6-(2-methyl-4-(tetrahydropyranyl) methoxybenzoyl)-9H-carbazol-3-yl]-1-(O-acetyloxime), ethanone-1-[9-ethyl-6-(2-methyl-5-(tetrahydrofuran)methoxybenzoyl)-9H-carbazol-3-yl]-1-(O-acetyloxime), ethanone-1-[9-ethyl-6-(2-methyl-5-(tetrahydropyranyl) methoxybenzoyl)-9H-carbazol-3-yl]-1-(O-acetyloxime), ethanone-1-[9-ethyl-6-2-methyl-4-(2,2-dimethyl-1,3-dioxolan)benzoyl)-9H-carbazol-3-yl]-1-(O-acetyloxime), and ethanone-1-[9-ethyl-6-{2-methyl-4-(2,2-dimethyl-1,3-dioxolan)methoxybenzoyl}-9H-carbazol-3-yl]-1-(O-acetyloxime).

The O-acyl oxime compound is preferably 1-[4-(phenylthio)phenyl]-octane-1,2-dione 2-(O-benzoyloxime) (such as OXE-01 manufactured by Ciba Specialty Chemicals), 1-[9-ethyl-6-(2-methylbenzoyl)-9H-carbazol-3-yl]-ethanone 1-(O-acetyloxime) (such as OXE-02 manufactured by Ciba Specialty Chemicals), ethanone-1-[9-ethyl-6-(2-methyl-4-(tetrahydropyranyl) methoxybenzoyl)-9H-carbazol-3-yl]-1-(O-acetyloxime), or ethanone-1-[9-ethyl-6-{2-methyl-4-(2,2-dimethyl-1,3-dioxolan)methoxybenzoyl}-9H-carbazol-3-yl]-1-(O-acetyloxime). The O-acyl oxime compound can be used alone or in combination, depending on actual demand. When the O-acyl oxime compound is absent, the adhesion of the photosensitive resin composition after development is poor.

The triazine compound includes but not limited to a vinyl-halogenated methyl-s-triazine compound, a 2-(naphtho-1-yl)-4,6-bis-halogenated methyl-s-triazine compound, or a 4-(p-aminophenyl)-2,6-di-halogenated methyl-s-triazine compound.

Specific examples of the vinyl-halogenated methyl-s-triazine compound are 2,4-bis(trichloromethyl)-6-(p-methoxy)styryl-s-triazine, 2,4-bis(trichloromethyl)-3-(1-p-dimethylaminophenyl-1,3-butadiene group)-s-triazine, and 2-trichloromethyl-3-amino-6-(p-methoxy) styryl-s-triazine.

Specific examples of the 2-(naphtho-1-yl)-4,6-bis-halogenated methyl-s-triazine compound are 2-(naphtho-1-yl)-4,6-bistrichloromethyl-s-triazine, 2-(4-methoxy-naphtho-1-yl)-4,6-bis-trichloromethyl-s-triazine, 2-(4-ethoxy-naphtho-1-yl)-4,6-bis-trichloromethyl-s-triazine, 2-(4-butoxy-naphtho-1-yl)-4,6-bis-trichloromethyl-s-triazine, 2-[4-(2-methoxyethyl)-naphtho-1-yl]-4,6-bis-trichloromethyl-s-triazine, 2-[4-(2-ethoxyethyl)-naphtho-1-yl]-4,6-bis-trichloromethyl-s-triazine, 2-[4-(2-butoxyethyl)-naphtho-1-yl]-4,6-bis-trichloromethyl-s-triazine, 2-(2-methoxy-naphtho-1-yl)-4,6-bistrichloromethyl-s-triazine, 2-(6-methoxy-5-methyl-naphtho-2-yl)-4,6-bis-trichloromethyl-s-triazine, 2-(6-methoxynaphtho-2-yl)-4,6-bis-trichloromethyl-s-triazine, 2-(5-methoxy-naphto-1-yl)-4,6-bis-trichloromethyl-s-triazine, 2-(4,7-dimethoxy-naphtho-1-yl)-4,6-bis-trichloromethyl-s-triazine, 2-(6-ethoxy-naphtho-2-yl)-4,6-bis-trichloromethyl-s-triazine, and 2-(4,5-dimethoxy-naphtho-1-yl)-4,6-bis-trichloromethyl-s-triazine.

Specific examples of the 4-(p-aminophenyl)-2,6-di-halogenated methyl-s-triazine compound are 4-[p-N,N-di(ethoxycarbonylmethyl) aminophenyl]-2,6-di(trichloromethyl)-s-triazine, 4-[o-methyl-p-N,N-di(ethoxycarbonylmethyl)aminophenyl]-2,6-di(trichloromethyl)-s-triazine, 4-[p-N,N-di(chloroethyl) aminophenyl]-2,6-di(trichloromethyl)-s-triazine, 4-[o-methyl-p-N,N-di(chloroethyl) aminophenyl]-2,6-di(trichloromethyl)-s-triazine, 4-(p-N-chloroethylaminophenyl)-2,6-di(trichloromethyl)-s-triazine, 4-(p-N-ethoxycarbonylmethylaminophenyl)-2,6-di(trichloromethyl)-s-triazine, 4-[p-N,N-di(phenyl)aminophenyl]-2,6-di(trichloromethyl)-s-triazine, 4-(p-N-chloroethylcarbonylaminophenyl)-2,6-di(trichloromethyl)-s-triazine, 4-[p-N-(p-methoxyphenyl)carbonylaminophenyl]-2,6-di(trichloromethyl)-s-triazine, 4-[m-N,N-di(ethoxycarbonylmethyl)aminophenyl]-2,6-di(trichloromethyl)-s-triazine, 4-[m-bromo-p-N,N-di(ethoxycarbonylmethyl)aminophenyl]-2,6-di(trichloromethyl)-s-triazine, 4-[m-chloro-p-N,N-di(ethoxycarbonylmethyl)aminophenyl]-2,6-di(trichloromethyl)-s-triazine, 4-[m-fluoro-p-N,N-di(ethoxycarbonylmethyl) aminophenyl]-2,6-di(trichloromethyl)-s-triazine, 4-[o-bromo-p-N,N-di(ethoxycarbonylmethyl) aminophenyl]-2,6-di(trichloromethyl)-s-triazine, 4-[o-chloro-p-N,N-di(ethoxycarbonylmethyl)aminophenyl-2,6-di(trichloromethyl)-s-triazine, 4-[o-fluoro-p-N,N-di(ethoxycarbonylmethyl) aminophenyl]-2,6-di(trichloromethyl)-s-triazine, 4-[o-bromo-p-N,N-di(chloroethyl)aminophenyl]-2,6-di(trichloromethyl)-s-triazine, 4-[o-chloro-p-N,N-di(chloroethyl)aminophenyl]-2,6-di(trichloromethyl)-s-triazine, 4-[o-fluoro-p-N,N-di(chloroethyl)aminophenyl]-2,6-di(trichloromethyl)-s-triazine, 4-[m-bromo-p-N,N-di(chloroethyl)aminophenyl]-2,6-di(trichloromethyl)-s-triazine, 4-[m-chloro-p-N,N-di(chloroethyl) aminophenyl]-2,6-di(trichloromethyl)-s-triazine, 4-[m-fluoro-p-N,N-di(chloroethyl)aminophenyl]-2,6-di(trichloromethyl)-s-triazine, 4-(m-bromo-p-N-ethoxycarbonylmethylaminophenyl)-2,6-di(trichloromethyl)-s-triazine, 4-(m-chloro-p-N-ethoxycarbonylmethylaminophenyl)-2,6-di(trichloromethyl)-s-triazine, 4-(m-fluoro-p-N-ethoxycarbonylmethylaminophenyl)-2,6-di(trichloromethyl)-s-triazine, 4-(o-bromo-p-N-ethoxycarbonylmethylaminophenyl)-2,6-di(trichloromethyl)-s-triazine, 4-(o-chloro-p-N-ethoxycarbonylmethylaminophenyl)-2,6-di(trichloromethyl)-s-triazine, 4-(o-fluoro-p-N-ethoxycarbonylmethylaminophenyl)-2,6-di(trichloromethyl)-s-triazine, 4-(m-bromo-p-N-chloroethylaminophenyl)-2,6-di(trichloromethyl)-s-triazine, 4-(m-chloro-p-N-chloroethylaminophenyl)-2,6-di(trichloromethyl)-s-triazine, 4-(m-fluoro-p-N-chloroethylaminophenyl)-2,6-di(trichloromethyl)-s-triazine, 4-(o-bromo-p-N-chloroethylaminophenyl)-2,6-di(trichloromethyl)-s-triazine, 4-(o-chloro-p-N-chloroethylaminophenyl)-2,6-di(trichloromethyl)-s-triazine, 4-(o-fluoro-p-N-chloroethylaminophenyl)-2,6-di(trichloromethyl)-s-triazine, and 2,4-di(trichloromethyl)-6-[3-bromo-4-[N,N-di(ethoxycarbonylmethyl) amino] phenyl]-1,3,5-triazine.

The triazine compound preferably is 4-[m-bromo-p-N,N-di(ethoxycarbonylmethyl)aminophenyl]-2,6-di(trichloromethyl)-s-triazine or 2,4-bis(trichloromethyl)-6-p-methoxystyryl-s-triazine. The triazine compound can be used alone or in combination, depending on actual demand

Specific examples of the acetophenone compound are p-dimethylamino-acetophenone, α,α′-dimethoxyazoxy-acetophenone, 2,2′-dimethyl-2-phenyl-acetophenone, p-methoxy-acetophenone, 2-methyl-1-(4-methylthio phenyl)-2-morpholino-1-propanone, and 2-benzyl-2-N,N-dimethylamino-1-(4-morpholinophenyl)-1-butanone. The acetophenone compound preferably is 2-methyl-1-4-(methylthiophenyl)-2-morpholino-1-propanone or 2-benzyl-2-N,N-dimethylamino-1-(4-morpholinophenyl)-1-butanone. The acetophenone compound can be used alone or in combination, depending on actual demand

Specific examples of the biimidazole compound are 2,2′-bis(o-chlorophenyl)-4,4′,5,5′-tetraphenyl-biimidazole, 2,2′-bis(o-fluorophenyl)-4,4′,5,5′-tetraphenyl-biimidazole, 2,2′-bis(o-methyl phenyl)-4,4′,5,5′-tetraphenyl-biimidazole, 2,2′-bis(o-methoxyphenyl)-4,4′,5,5′-tetraphenyl-biimidazole, 2,2′-bis(o-ethylphenyl)-4,4′,5,5′-tetraphenyl-biimidazole, 2,2′-bis(p-methoxyphenyl)-4,4′,5,5′-tetraphenyl-biimidazole, 2,2′-bis(2,2′,4,4′-tetramethoxyphenyl)-4,4′,5,5′-tetraphenyl-biimidazole, 2,2′-bis(2-chlorophenyl)-4,4′,5,5′-tetraphenyl-biimidazole, and 2,2′-bis(2,4-dichlorophenyl)-4,4′,5,5′-tetraphenyl-biimidazole. The biimidazole compound is preferably 2,2′-bis(2,4-dichlorophenyl)-4,4′,5,5′-tetraphenyl-biimidazole. The biimidazole compound can be used alone or in combination, depending on actual demand

Specific examples of the benzophenone compound are thioxanthone, 2,4-diethylthioxanthone, thioxanthone-4-sulfone, benzophenone, 4 4′-bis(dimethylamino)benzophenone, and 4,4′-bis(diethylamino)benzophenone. The benzophenone compound is preferably 4,4′-bis(diethylamino)benzophenone. The benzophenone compound can be used alone or in combination, depending on actual demand

Specific examples of the a-diketone compound are benzil and acetyl. Specific examples of the ketone alcohol compound are benzoin. Specific examples of the ketone alcohol ether compound are benzoin methyl ether, benzoin ethyl ether, or benzoin iso-propyl ether. Specific examples of the acylphosphine oxide compound are 2,4,6-trimethylbenzoyl diphenyl phosphine oxide or bis-(2,6-dimethoxybenzoyl)-2,4,4-trimethyl benzyl phosphine oxide. Specific examples of the quinone compound are anthraquinone or 1,4-naphthoquinone. Specific examples of the halogen-containing compound are phenacyl chloride, tribromomethyl phenylsulfone, or tri(trichloromethyl)-s-triazine. Specific examples of the peroxide compound are di-tert-butyl peroxide. The α-diketone compound, ketone alcohol compound, ketone alcohol ether compound, acylphosphine oxide compound, quinone compound, halogen-containing compound, and peroxide compound can be used individually or in combination, depending on actual demand

Based on 100 parts by weight of the used amount of the alkali-soluble resin (A), the used amount of the photoinitiator (C) is from 10 parts by weight to 80 parts by weight, preferably 12 parts by weight to 75 parts by weight, and more preferably 15 parts by weight to 70 parts by weight.

The solvent (D) according to the invention is able to dissolve the alkali-soluble resin (A), the compound (B) containing the ethylenically unsaturated group, the photoinitiator (C), the black pigment (E) and the thermal initiator (F), and not interact with the components described above, and has a suitable volatility.

Specific examples of the solvent (D) are an alkylene glycol monoalkyl ether compound such as ethylene glycol monomethyl ether, ethylene glycol monoethyl ether, diethylene glycol monoethyl ether, diethylene glycol mono-n-propyl ether, diethylene glycol mono-n-butyl ether, triethylene glycol monomethyl ether, triethylene glycol monoethyl ether, propylene glycol monomethyl ether, propylene glycol monoethyl ether, dipropylene glycol monomethyl ether, dipropylene glycol monoethyl ether, dipropylene glycol mono-n-propyl ether, dipropylene glycol mono-n-butyl ether, tripropylene glycol monomethyl ether, and tripropylene glycol monoethyl ether; alkylene glycol monoalkyl ether acetate compounds such as ethylene glycol methyl ether acetate, ethylene glycol ethyl ether acetate, propylene glycol methyl ether acetate, and propylene glycol ethyl ether acetate; other ether compounds such as diethylene glycol dimethyl ether, diethylene glycol methyl ethyl ether, diethylene glycol diethyl ether, and tetrahydrofuran; ketone compounds such as methyl ethyl ketone, cyclohexanone, 2-heptanone, and 3-heptanone or diacetone alcohol; alkyl lactate compounds such as methyl lactate and ethyl lactate; other ester compounds such as methyl 2-hydroxy-2-methylpropanoate, ethyl 2-hydroxy-2-methylpropanoate, methyl 3-methoxypropanoate, ethyl 3-methoxypropanoate, methyl 3-ethoxypropanoate, ethyl 3-ethoxypropanoate, ethyl ethoxyacetate, ethyl hydroxyacetate, methyl 2-hydroxy-3-methylbutyrate, 3-methyl-3-methoxybutyl acetate, 3-methyl-3-methoxybutyl propanoate, ethyl acetate, n-propyl acetate, isopropyl acetate, n-butyl acetate, isobutyl acetate, n-amyl acetate, isoamyl acetate, n-butyl propanoate, ethyl butyrate, n-propyl butyrate, isopropyl butyrate, n-butyl butyrate, methyl pyruvate, ethyl pyruvate, n-propyl pyruvate, methyl acetoacetate, ethyl acetoacetate, and ethyl 2-oxybutyrate; aromatic hydrocarbons such as toluene and xylene; carboxylic amines such as N-methylpyrrolidone, N,N-dimethylformamide, and N,N-dimethylacetamide; or any combination thereof. The solvent (D) can generally be used alone or in combination.

Based on 100 parts by weight of the used amount of the alkali-soluble resin (A), the used amount of the solvent (D) is from 1000 to 8000 parts by weight; preferably 1200 to 7000 parts by weight; more preferably 1500 to 6000 parts by weight.

The black pigment (E) suitable for the invention is preferably a black pigment having heat-resistance, light-resistance, and solvent-resistance.

Specific examples of the black pigment (E) are an organic black pigment such as perylene black, cyanine black, and aniline black; a near-black mixture of organic pigments obtained by mixing two or more organic pigments selected from red, blue, green, purple, yellow, cyanine, and magenta pigment; a shading material such as carbon black, chromium oxide, ferric oxide, titanium black, and graphite, wherein the carbon black can include but is not limited to C.I. pigment black 7, such as products manufactured by Mitsubishi Chemical Co. (product names MA100, MA230, MA8, #970, #1000, #2350, and #2650). The black pigment (E) can generally be used individually or in combination.

Based on 100 parts by weight of the used amount of the alkali-soluble resin (A), the used amount of the black pigment (E) is from 140 to 1200 parts by weight; preferably 170 to 1100 parts by weight; more preferably 200 to 1000 parts by weight.

The thermal initiator (F) according to the invention is not particularly limited. In one embodiment of the invention, the thermal initiator (F) includes but not limited to an azo compound, an organic peroxide compound, and a hydrogen peroxide compound.

Specific examples of the azo compound are 2,2′-azobis(isobutyronitrile), 2,2′-azobis-2-methyl butyronitrile, 1,1′-azobis(cyclohexane-1-carbonitrile), 2,2′-azobis(2,4-dimethylvaleronitrile), 1-[(1-cyano-1-methylethyl)azo]formamide, 2,2-azobis{2-methyl-N-[1,1-bis(hydroxymethyl)-2-hydroxyethyl]propionamide, 2,2′-azobis[N-(2-propenyl)-2-methylpropionamide, 2,2′-azobis[N-(2-propenyl)-2-ethyl propionamide, 2,2′-azobis(N-butyl-2-methylpropionamide), 2,2′-azobis(N-cyclohexyl-2-methyl propionamide), 2,2′-azobis(dimethyl-2-methyl propionamide), 2,2′-azobis(dimethyl-2-methyl propionate) and 2,2′-azobis(2,4,4-trimethyl pentene).

Specific examples of the organic peroxide compound are benzoyl peroxide, tertiary butyl peroxide, diisobutyryl peroxide, cumyl peroxyneodecanoate, di-n-propyl peroxydicarbonate, diisopropyl peroxydicarbonate, di-sec-butyl peroxydicarbonate, 1,1,3,3-tetramethylbutyl peroxyneodecanoate, di(4-t-butyl cyclohexyl) peroxydicarbonate, 1-cyclohexyl-1-methylethyl peroxyneodecanoate, di(2-ethoxy-ethyl) peroxydicarbonate, di(2-ethylhexyl) peroxydicarbonate, t-hexyl peroxyneodecanoate, dimethoxybutyl peroxydicarbonate, t-butyl peroxyneodecanoate, t-hexyl peroxypivalate, t-butyl peroxypivalate, di(3,5,5-trimethyl hexanoyl) peroxide, di-n-octanoyl peroxide, dilauroyl peroxide, distearoyl peroxide, 1,1,3,3-tetramethylbutylperoxy-2-ethylhexanoate, 2,5-dimethyl-2,5-di(2-ethylhexanoylperoxy)hexane, t-hexylperoxy-2-ethylhexanoate, di(4-methylbenzoyl) peroxide, t-butylperoxy-2-ethylhexanoate, dibenzoyl peroxide, t-butyl peroxyisobutyrate, 1,1-di(t-butyl peroxy)-2-methylcyclohexane, 1,1-di(t-hexyl peroxy)-3,3,5-trimethylcyclohexane, 1,1-di(t-hexylperoxy) cyclohexane, 1,1-di(t-butylperoxy) cyclohexane, 2,2-di[4,4-di(t-butylperoxy) cyclohexyl] propane, t-hexyl peroxy isopropyl monocarbonate, t-butylperoxy maleate, t-butyl peroxy-3,5,5-trimethyl hexanoate, t-butyl peroxy laurate, 2,5-dimethyl-2,5-di-(3-methyl benzoyl peroxy)hexane, t-butyl peroxy isopropyl monocarbonate, t-butyl peroxy-2-ethylhexyl monocarbonate, t-hexyl peroxy benzoate, 2,5-dimethyl-2,5-di(benzoyl peroxy)hexane, t-butyl peroxy acetate, 2,2-di(t-butylperoxy) butane, t-butyl peroxy benzoate, n-butyl-4,4-di(t-butylperoxy) valerate, di(2-t-butyl peroxy isopropyl) benzene, dicumyl peroxide, di-t-hexyl peroxide, 2,5-dimethyl-2,5-di(t-butyl peroxy) hexane, di-t-butyl peroxide, 2,5-dimethyl-2,5-di(t-butylperoxy) hexyne, t-butyl trimethylsilyl peroxide, di(3-methylbenzoyl) peroxide, benzoyl (3-methylbenzoyl) peroxide and dibenzoyl peroxide.

Specific examples of the hydrogen peroxide compound are p-menthane hydroperoxide, diisopropylbenzene hydroperoxide, 1,1,3,3-tetramethyl butyl hydroperoxide, cumene hydroperoxide and t-butyl hydroperoxide.

The thermal initiator (F) preferably is 2,2′-azobis(isobutyronitrile), 2,2′-azobis-2-methyl butyronitrile, 2,2′-azobis(2,4-dimethylvaleronitrile), diisobutyryl peroxide, dibenzoyl peroxide, t-butyl peroxyisobutyrate, cumene hydroperoxide and cumyl peroxyneodecanoate. The thermal initiator (F) can be used alone or in a combination of two or more.

In one embodiment of the invention, based on 100 parts by weight of the used amount of the alkali-soluble resin (A), the used amount of the thermal initiator (F) is from 4 parts by weight to 40 parts by weight, preferably 5 parts by weight to 35 parts by weight, and more preferably 6 parts by weight to 30 parts by weight. When the thermal initiator (F) is used, the resolution of the photosensitive resin composition can be further improved.

Without affecting the efficacy of the invention, the photosensitive resin composition according to the invention can further comprise an additive (G). The additive (G) includes but is not limited to a surfactant, a filler, an adhesion promoting agent, a bridging agent, an antioxidant, an anti-coagulant, or other polymers other than the alkali-soluble resin (A) that can improve any property (such as mechanical property).

The aforementioned surfactant can be selected from the group consisting of a cationic, an anionic, a nonionic, a zwitterionic, a polysiloxane, and a fluoro surfactant, or any combination thereof. Specifically, the surfactant includes but is not limited to, polyoxyethylene alkyl ethers such as polyoxyethylene lauryl ether, polyoxyethylene stearyl ether, or polyoxyethylene oleyl ether; polyoxyethylene alkyl phenyl ethers such as polyoxyethylene octyl phenyl ether or polyoxyethylene nonyl phenyl ether; polyethylene glycol diesters such as polyethylene glycol dilaurate and polyethylene glycol distearate; sorbitol anhydride fatty acid esters; fatty acid-modified polyesters; and tertiary amine-modified polyurethanes. The aforementioned surfactant can be used alone or in combination.

Specific examples of the surfactant are KP (manufactured by Shin-Etsu Chemical Co., Ltd.), SF-8427 (manufactured by Toray Dow Corning Silicone Co., Ltd.), Polyflow (manufactured by Kyoeisha Oil Chemical Co., Ltd.), F-Top (manufactured by Tochem Product Co., Ltd.), Megafac (manufactured by Dainippon Ink and Chemicals Co., Ltd.), Fluorade (manufactured by Sumitomo 3M, Ltd.), Asahi Guard (manufactured by Asahi glass Co., Ltd.), Surflon (manufactured by Asahi glass Co., Ltd.), or SINOPOL E8008 (manufactured by Sino-Japan Chemical Co., Ltd.).

The filler includes but is not limited to glass or aluminium.

Specific examples of the adhesion promoting agent are vinyltrimethoxysilane, vinyltriethoxysilane, vinyltris(2-methoxyethoxy)silane, N-(2-aminoethyl)-3-aminopropylmethyldimethoxysilane, N-(2-aminoethyl)-3-aminopropyltrimethoxysilane, 3-aminopropyltriethoxysilane, 3-glycidoxypropyltrimethoxysilane, 3-glycidoxypropylmethyldiethoxysilane, 2-(3,4-epoxycyclohexyl)ethyltrimethoxysilane, 3-chloropropylmethyldimethoxysilane, 3-chloropropyltrimethoxysilane, 3-methacryloyloxypropyl trimethoxysilane and 3-mercaptopropyltrimethoxysilane.

Specific examples of the antioxidant are 2,2-thiobis(4-methyl-6-t-butyl phenol) or 2,6-di-t-butyl phenol.

Specific example of the anti-coagulant is sodium polyacrylate.

Specific examples of the bridging agent are epoxy compounds such as 1031S and 157S-70 manufactured by Japan Epoxy Resins Co., Ltd, or resins.

Based on 100 parts by weight of the used amount of the alkali-soluble resin (A), the used amount of the filler, the adhesion promoting agent, the antioxidant, the anti-coagulant, or polymers other than the alkali-soluble resin (A) in the additive (G) is preferably below 10 parts by weight; more preferably below 6 parts by weight.

Based on 100 parts by weight of the used amount of the alkali-soluble resin (A), the used amount of the surfactant in the additive (G) is preferably below 6 parts by weight; more preferably below 4 parts by weight.

Based on 100 parts by weight of the used amount of the alkali-soluble resin (A), the used amount of the bridging agent in the additive (G) is below 100 parts by weight; more preferably below 80 parts by weight.

The photosensitive resin composition of the invention is prepared by, for instance, placing and stirring the alkali-soluble resin (A), the compound (B) containing the ethylenically unsaturated group, the photoinitiator (C), the solvent (D), the black pigment (E), and the thermal initiator (F) in an agitator such that the ingredients are evenly mixed into a solution state. When necessary, the additive (G) such as the surfactant, the filler, the adhesion promoting agent, the bridging agent, the antioxidant, and the anti-coagulant can be added. After the solution is evenly mixed, the photosensitive resin composition in a solution state can be obtained.

The preparation method of the photosensitive resin composition of the invention is not particularly limited. For instance, the black pigment (E) can be directly added and dispersed in other ingredients of the photosensitive resin composition in order to form the photosensitive resin composition. Alternately, a portion of the pigment (E) can first be dispersed in a portion of a medium including the alkali-soluble resin (A) and the solvent (D) to form a pigment dispersion solution, and then mixed with the rest of the the compound (B) containing the ethylenically unsaturated group, the photoinitiator (C), the thermal initiator (F), the alkali-soluble resin (A), and the solvent (D) to prepare the photosensitive resin composition. The dispersion steps of the black pigment (E) can be performed by mixing the ingredients with a mixer such as a beads mill or a roll mill

The present invention also provides a black matrix, which is formed by photosensitive resin composition as mentioned above.

The black matrix is obtained by applying the treatments of pre-bake, exposure, development, and post-bake to the aforementioned photosensitive resin composition in turn, wherein when the film thickness of the black matrix is 1 μm, the range of the optical density can be at least 3.0, preferably 3.2 to 5.5, and more preferably 3.5 to 5.5.

The black matrix according to the invention can form a pre-baked coating film on a substrate by coating the photosensitive resin composition on the substrate through a coating method such as spin-coating or cast coating and then removing the solvent through reduced pressure drying and a pre-bake treatment. The conditions of the reduced pressure drying and pre-bake can be specified based on the type and the mix ratio of each ingredient. Generally, the reduced pressure drying can be performed at a pressure of less than 200 mmHg for 1 second to 20 seconds and the pre-bake treatment can be performed at a temperature of 70° C. to 110° C. for 1 minute to 15 minutes. After the pre-bake treatment, the coating film is exposed by a specified mask, and the unnecessary portion is removed by immersing the exposed coating film in a developing solution at a temperature of 23±2° C. for 15 seconds to 5 minutes so as to form a specific pattern. The light used in the exposure step is preferably an ultraviolet light such as a g-line, an h-line, or an i-line, and the ultra-violet irradiation device can be, for instance, a(n) (ultra-)high pressure mercury vapor lamp or a metal halide lamp.

Specific examples of the developing solution are solutions of basic compounds such as sodium hydroxide, potassium hydroxide, sodium carbonate, sodium hydrogen carbonate, potassium carbonate, potassium hydrogen carbonate, sodium silicate, sodium methyl silicate, aqueous ammonia, ethylamine, diethylamine, dimethyl ethanolamine, tetramethylammonium hydroxide, tetraethylammonium hydroxide, choline, pyrrole, piperidine, and 1,8-diazabicyclo-[5,4,0]-7-undecene. The concentration of the developing solution is generally from 0.001 to 10 percentages by weight (wt %); preferably from 0.005 to 5 percentages by weight (wt %); more preferably 0.01 to 1 percentages by weight (wt %).

Generally, after treatment with the developing solution, the pattern is first washed with water and then air-dried with compressed air or compressed nitrogen. Next, a heating device such as a hot plate or an oven is used to perform the post-bake treatment. The temperature of the post-bake is generally in the range of 150° C. to 250° C., wherein the heating time is about 5 minutes to 60 minutes when the hot plate is used and about 15 minutes to 150 minutes when the oven is used. After the treatment steps, the black matrix can be formed on the substrate.

Specific examples of the substrate are an alkali-free glass, a soda-lime glass, a hard glass (such as Pyrex glass), and a silica glass used in a liquid crystal display device, and such glasses with a transparent conductive film attached thereon; or a substrate such as a photoelectric conversion device substrate (such as a silicon substrate) used in, for instance, a solid imaging device.

The present invention also provides a color filter comprising the black matrix as mentioned above.

The formation method of the color filter according to the invention can be performed by coating the photosensitive composition for the color filter, which is mixed into a solution state, on a substrate by a coating method such as spin-coating, cast coating, or roll coating, wherein the black matrix for separating each pixel color layer is formed on the substrate in advance by using the photosensitive resin composition. After coating, most of the solvent is removed by a method of reduced pressure drying, and then the solvent is removed by pre-baking to form a pre-baked coating film. The aforementioned conditions of the reduced pressure drying and pre-bake can be specified based on the type and the mix ratio of each ingredient. Generally, the reduced pressure drying can be performed at a pressure of 0 mmHg to 200 mmHg for 1 second to 60 seconds, and the pre-bake can be performed at a temperature of 70° C. to 110° C. for 1 minute to 15 minutes. After the pre-bake, the coating film is exposed by a specified mask, and the unnecessary portion is removed by immersing and developing the exposed coating film in a developing solution at a temperature of 23±2° C. for 15 seconds to 5 minutes to form a specific pattern. The light used in the exposure step is preferably an ultraviolet light such as a g-line, a h-line, or an i-line, and the ultra-violet irradiation device can be, for instance, a(n) (ultra-)high pressure mercury vapor lamp or a metal halide lamp.

After development, the pattern is first washed with water and then air-dried with compressed air or compressed nitrogen, and then a heating device such as a hot plate or an oven is used to perform the post-bake treatment. The conditions of the post-bake treatment are the same as described above and are not repeated herein.

The steps are repeated in sequence for the photosensitive composition of each color (mainly including red, green, and blue) to prepare the pixel layer of the color filter. Next, in a vacuum environment with a temperature in the range of 220° C. to 250° C., an indium tin oxide (ITO) film is formed on the pixel layer. When needed, after the ITO film is etched and wired, a polyimide for a liquid crystal alignment film is coated and burned to obtain the color filter for a liquid crystal display element.

The present invention further provides a liquid crystal display element comprising the color filter as mentioned above.

The liquid crystal display element according to the invention can be formed by the following method: the color filter substrate formed by the preparation method of the color filter and a driving substrate with a thin film transistor (TFT) are placed opposite to each other with a gap (cell gap) between the two, and then the surrounding area of the two substrates is laminated with a sealing agent. Next, a liquid crystal is injected into the gap separated by the surface of the substrates and the sealing agent to seal the injection hole and to form a liquid crystal cell. Then, a polarizer is laminated to the outer surface of the liquid crystal cell, i.e. the other side surfaces of each of the substrates forming the liquid crystal cell so as to fabricate the liquid crystal display element.

The liquid crystal can be a liquid crystal compound or a liquid crystal composition. The specific composition of the liquid crystal is not particularly limited, and any liquid crystal compound and liquid crystal composition known by those skilled in the art can be used.

Moreover, the liquid crystal alignment film is used to limit the alignment of the liquid crystal molecules and is not particularly limited, and can be any inorganic matter or organic matter. Furthermore, the technique of forming the liquid crystal alignment film is well known by those skilled in the art and is thus not repeated herein.

The following examples are given for the purpose of illustration only and are not intended to limit the scope of the present invention.

### Preparation of a Diol Compound (a-1) Containing a Polymeric Unsaturated Group

### Preparation Example 1

100 parts by weight of a fluorene epoxy compound (model number: ESF-300, made by Nippon Steel Chemical, epoxy equivalent: 231), 30 parts by weight of acrylic acid, 0.3 parts by weight of benzyltriethylammonium chloride, 0.1 parts by weight of 2,6-di-tert-butyl-p-cresol and 130 parts by weight of propylene glycol monomethyl ether acetate were added in a 500 ml four-neck flask in a continuous manner. The feeding speed was controlled at 25 parts by weight/minute, the temperature of the reaction process was maintained at 100° C. to 110° C., and the mixture was reacted for 15 hours to obtain a light yellow transparent mixture solution having a solid content of 50 wt %. Then, steps of extraction, filtration, and heating and drying were performed on the light yellow transparent mixture solution to obtain a diol compound (a-1-1) containing a polymeric unsaturated group of preparation example 1 having a solid content of 99.9 wt %.

### Preparation Example 2

100 parts by weight of a fluorene epoxy compound (model number: PG-100, made by Osaka Gas, epoxy equivalent: 259), 35 parts by weight of methacrylic acid, 0.3 parts by weight of benzyltriethylammonium chloride, 0.1 parts by weight of 2,6-di-tert-butyl-p-cresol and 135 parts by weight of propylene glycol monomethyl ether acetate were added in a 500 ml four-neck flask in a continuous manner. The feeding speed was controlled at 25 parts by weight/minute, the temperature of the reaction process was maintained at 100° C. to 110° C., and the mixture was reacted for 15 hours to obtain a light yellow transparent mixture solution having a solid content of 50 wt %. Steps of extraction, filtration, and heating and drying were performed on the light yellow transparent mixture solution to obtain a diol compound (a-1-2) containing a polymeric unsaturated group of preparation example 2 having a solid content of 99.9 wt %.

### Preparation Example 3

100 parts by weight of a fluorene epoxy compound (model number: ESF-300, made by Nippon Steel Chemical, epoxy equivalent: 231), 100 parts by weight of 2-methacryloyl oxyethyl succinate, 0.3 parts by weight of benzyltriethylammonium chloride, 0.1 parts by weight of 2,6-di-tert-butyl-p-cresol and 200 parts by weight of propylene glycol monomethyl ether acetate were added in a 500 ml four-neck flask in a continuous manner. The feeding speed was controlled at 25 parts by weight/minute, the temperature of the reaction process was maintained at 100° C. to 110° C., and the mixture was reacted for 15 hours to obtain a light yellow transparent mixture solution having a solid content of 50 wt %. Steps of extraction, filtration, and heating and drying were performed on the light yellow transparent mixture solution to obtain a diol compound (a-1-3) containing a polymeric unsaturated group of preparation example 3 having a solid content of 99.9 wt %.

### Preparation Example 4

First, 0.3 moles of bis(4-hydroxyphenyl)sulfone, 9 moles of epichlorohydrin and 0.003 moles of tetramethyl ammonium chloride were added in a 1000 mL three-neck flask provided with a mechanical stirrer, a thermometer, and a reflux condenser. Next, the flask was heated to 105° C. while stirring and reacted at 105° C. for 9 hours. Then, unreacted epichlorohydrin was distilled under reduced pressure. Next, the reaction system was cooled to room temperature and 9 moles of benzene and 0.5 moles of sodium hydroxide (30 wt % aqueous solution formed by dissolving in water) were added thereto while stirring. Then, the temperature was raised to 60° C. and maintained at 60° C. for 3 hours. Next, the reaction solution was washed with water repeatedly until no chloride ions remained (tested with silver nitrate). The solvent benzene was removed via distillation under reduced pressure, and then the reaction solution was dried at 75° C. for 24 hours to obtain an epoxy compound of bis(4-hydroxyphenyl)sulfone.

100 parts by weight of an epoxy compound (epoxy equivalent: 181) of bis(4-hydroxyphenyl)sulfone, 30 parts by weight of acrylic acid, 0.3 parts by weight of benzyltriethylammonium chloride, 0.1 parts by weight of 2,6-di-tert-butyl-p-cresol and 130 parts by weight of propylene glycol monomethyl ether acetate were added in a 500 ml four-neck flask in a continuous manner. The feeding speed was controlled at 25 parts by weight/minute, the temperature of the reaction process was maintained at 100° C. to 110° C., and the mixture was reacted for 15 hours to obtain a light yellow transparent mixture solution having a solid content of 50 wt %. Steps of extraction, filtration, and heating and drying were performed on the light yellow transparent mixture solution to obtain a diol compound (a-1-4) containing a polymeric unsaturated group of preparation example 4 having a solid content of 99.9 wt %.

### Preparation Example 5

0.3 moles of bis(4-hydroxyphenyl)hexafluoropropane, 9 moles of epichlorohydrin, and 0.003 moles of tetramethyl ammonium chloride were added in a 1000 mL three-neck flask provided with a mechanical stirrer, a thermometer, and a reflux condenser. Next, the flask was heated to 105° C. while stirring and reacted at 105° C. for 9 hours. Then, unreacted epichlorohydrin was distilled under reduced pressure. Next, the reaction system was cooled to room temperature and 9 moles of benzene and 0.5 moles of sodium hydroxide (30 wt % aqueous solution formed by dissolving in water) were added thereto while stirring. Then, the temperature was raised to 60° C. and maintained at 60° C. for 3 hours. Next, the reaction solution was washed with water repeatedly until no chloride ions remained (tested with silver nitrate). The solvent benzene was removed via distillation under reduced pressure, and then the reaction solution was dried at 75° C. for 24 hours to obtain an epoxy compound of bis(4-hydroxyphenyl)hexafluoropropane.

100 parts by weight of an epoxy compound (epoxy equivalent: 224) of bis(4-hydroxyphenyl)hexafluoropropane, 35 parts by weight of methacrylic acid, 0.3 parts by weight of benzyltriethylammonium chloride, 0.1 parts by weight of 2,6-di-tert-butyl-p-cresol, and 135 parts by weight of propylene glycol monomethyl ether acetate were added in a 500 ml four-neck flask in a continuous manner. The feeding speed was controlled at 25 parts by weight/minute, the temperature of the reaction process was maintained at 100° C. to 110° C., and the mixture was reacted for 15 hours to obtain a light yellow transparent mixture solution having a solid content of 50 wt %. Steps of extraction, filtration, and heating and drying were performed on the light yellow transparent mixture solution to obtain a diol compound (a-1-5) containing a polymeric unsaturated group of preparation example 5 having a solid content of 99.9 wt %.

### Preparation Example 6

0.3 moles of bis(4-hydroxyphenyl)dimethylsilane, 9 moles of epichlorohydrin and 0.003 moles of tetramethyl ammonium chloride were added in a 1000 mL three-neck flask provided with a mechanical stirrer, a thermometer, and a reflux condenser. Next, the flask was heated to 105° C. while stirring and reacted at 105° C. for 9 hours. Then, unreacted epichlorohydrin was distilled under reduced pressure. Next, the reaction system was cooled to room temperature and 9 moles of benzene and 0.5 moles of sodium hydroxide (30 wt % aqueous solution formed by dissolving in water) were added thereto while stirring. Then, the temperature was raised to 60° C. and maintained at 60° C. for 3 hours. Next, the reaction solution was washed with water repeatedly until no chloride ions remained (tested by silver nitrate). The solvent benzene was removed via distillation under reduced pressure, and then the reaction solution was dried at 75° C. for 24 hours to obtain an epoxy compound of bis(4-hydroxyphenyl)dimethylsilane.

100 parts by weight of an epoxy compound (epoxy equivalent: 278) of bis(4-hydroxyphenyl)dimethylsilane, 100 parts by weight of 2-methacryloyl oxyethyl succinate, 0.3 parts by weight of benzyltriethylammonium chloride, 0.1 parts by weight of 2,6-di-tert-butyl-p-cresol, and 200 parts by weight of propylene glycol monomethyl ether acetate were added in a 500 ml four-neck flask in a continuous manner. The feeding speed was controlled at 25 parts by weight/minute, the temperature of the reaction process was maintained at 100° C. to 110° C., and the mixture was reacted for 15 hours to obtain a light yellow transparent mixture solution having a solid content of 50 wt %. Steps of extraction, filtration, and heating and drying were performed on the light yellow transparent mixture solution to obtain a diol compound (a-1-6) containing a polymeric unsaturated group of preparation example 6 having a solid content of 99.9 wt %.

### Synthesis of a First Alkai-Soluble Resin (A-1)

### Synthesis Example 1

1.0 mole of the diol compound containing the polymeric unsaturated group (a-1-1), 0.1 moles of 4,4′-hexafluoro isopropylidene diphthalic dianhydride (a-2-1-a), 0.2 moles of pyromellitic dianhydride (a-2-2-c), 0.4 moles of maleic acid (a-3-2-a), 1.0 mole of tetrahydrophthalic anhydride (a-3-2-b), 1.9 grams of benzyltriethylammonium chloride, 0.6 grams of 2,6-di-tert-butyl-p-cresol, and 750 grams of propylene glycol monomethyl ether acetate were added to a 500 mL four-neck flask at the same time to form a reaction solution. Here, “simultaneous addition” refers to adding the tetracarboxylic acid (a-2) or the acid dianhydride thereof and the dicarboxylic acid (a-3) or the acid anhydride thereof at the same reaction time. Then, the reaction solution was heated to 110° C. and reacted for 2 hours to obtain the first alkali-soluble resin (hereinafter as A-1-1) of synthesis example 1 having an acid value of 129 mgKOH/g and a number-average molecular weight of 2368.

### Synthesis Example 2

1.0 mole of the diol compound (a-1-2) containing the polymeric unsaturated group, 2.0 grams of benzyltriethylammonium chloride, 0.7 grams of 2,6-di-tert-butyl-p-cresol, and 700 grams of propylene glycol monomethyl ether acetate were added to a 500 mL four-neck flask to form a reaction solution. Then, 0.2 moles of 1,4-difluoropyromellitic dianhydride (a-2-1-b) and 0.2 moles of benzophenone tetracarboxylic dianhydride (a-2-2-b) were added and the mixture was reacted at 90° C. for 2 hours. Then, 1.2 moles of tetrahydrophthalic anhydride (a-3-2-b) was added and the mixture was reacted at 90° C. for 4 hours. Here, “successive addition” refers to respectively adding the tetracarboxylic acid (a-2) or the acid dianhydride thereof and the dicarboxylic acid (a-3) or the acid anhydride thereof at different reaction times. That is, the tetracarboxylic acid (a-2) or the acid dianhydride thereof is added first, and the dicarboxylic acid (a-3) or the acid anhydride thereof is added afterward. After the synthesis steps, the first alkali-soluble resin (hereinafter as A-1-2) of synthesis example 2 having an acid value of 125 mgKOH/g and a number-average molecular weight of 3388 can be obtained.

### Synthesis Examples 3, 5, 7 and 9

The first alkali-soluble resins of synthesis example 3, synthesis example 5, synthesis example 7 and synthesis example 9 were prepared with the same steps as synthesis example 1, and the difference were: the kind, the used amount, the reaction time, the reaction temperature, and the addition time of the reactants of the components of the first alkali-soluble resins were changed, wherein the compositions and the conditions were shown in Tables 1.

### Synthesis Examples 4, 6, 8 and 10

The first alkali-soluble resins of synthesis example 4, synthesis example 6, synthesis example 8, and synthesis example 10 were prepared with the same steps as synthesis example 2, and the difference were: the kind, the used amount, the reaction time, the reaction temperature, and the addition time of the reactants of the components of the first alkali-soluble resins were changed, wherein the compositions and the conditions were shown in Tables 1.

### Synthesis of a Second Alkai-Soluble Resin (A-2)

### Synthesis Example 11

1.0 mole of the diol compound (a-1-1) containing the polymeric unsaturated group, 1.9 grams of benzyltriethylammonium chloride, and 0.6 grams of 2,6-di-tert-butyl-p-cresol were dissolved in 700 grams of propylene glycol methyl ether acetate, and 0.3 moles of biphenyl tetracarboxylic acid (a-2-2-a) and 1.4 moles of maleic acid (a-3-2-a) were added at the same time. Then, the mixture was heated to 110° C. and reacted for 2 hours to obtain the second alkali-soluble resin (hereinafter as A-2-1) of synthesis example 11 having an acid value of 125 mgKOH/g and a number-average molecular weight of 2455.

### Synthesis Examples 12 to 13

The second alkali-soluble resins of synthesis example 12 to synthesis example 13 were prepared with the same steps as synthesis example 11, and the difference were: the kind, the used amount, the reaction time, the reaction temperature, and the addition time of the reactants of the components of the second alkali-soluble resins were changed (as shown in Table 2). It should be mentioned that, here, “simultaneous addition” refers to adding the tetracarboxylic acid (a-2) or the acid dianhydride thereof and the dicarboxylic acid (a-3) or the acid anhydride thereof at the same reaction time, and “successive addition” refers to respectively adding the tetracarboxylic acid (a-2) or the acid dianhydride thereof and the dicarboxylic acid (a-3) or the acid anhydride thereof at different reaction times. That is, the tetracarboxylic acid (a-2) or the acid dianhydride thereof is added first, and the dicarboxylic acid (a-3) or the acid anhydride thereof is added afterward.

TABLE 1
Synthesis of a first alkai-soluble resin (A-1)

| | | polymeric component | | | | | | | | | | | | | | | | | | |
|---|---|---|---|---|---|---|---|---|---|---|---|---|---|---|---|---|---|---|---|---|
| | | | | | | | | | | | | | | | dicarboxylic acid (a-3) or an acid anhydride thereof | | | | | |
| | | | | | | | | | | | | | | | (moles) | | | | | |
| | | | | | | | | tetracarboxylic acid (a-2) or acid dianhydride thereof | | | | | | | | | | | other | |
| | | | | | | | | (moles) | | | | | | | | | | | dicarboxylic acid | |
| | | | | | | | | tetracarboxylic acid (a-2-1) or an | | | | other tetracarboxylic acid | | | dicarboxylic acid (a-3-1) or an | | | | (a-3-2) or an | |
| | | diol compound (a-1) containing a | | | | | | acid dianhydride thereof | | | | (a-2-2) or an acid | | | acid anhydride thereof | | | | acid anhydride | |
| | | polymeric unsaturated group (moles) | | | | | | containing a fluorine atom | | | | dianhydride thereof | | | containing a fluorine atom | | | | thereof | |
| component | | a-1-1 | a-1-2 | a-1-3 | a-1-4 | a-1-5 | a-1-6 | a-2-1-a | a-2-1-b | a-2-1-c | a-2-1-d | a-2-2-a | a-2-2-b | a-2-2-c | a-3-1-a | a-3-1-b | a-3-1-c | a-3-1-d | a-3-2-a | a-3-2-b |
| synthesis example 1 | A-1-1 | 1.0 | | | | | | 0.1 | | | | | | 0.2 | | | | | 0.4 | 1.0 |
| synthesis example 2 | A-1-2 | | 1.0 | | | | | | 0.2 | | | | 0.2 | | | | | | | 1.2 |
| synthesis example 3 | A-1-3 | | | 1.0 | | | | | | 0.1 | 0.2 | 0.3 | | | | | | | | 0.8 |
| synthesis example 4 | A-1-4 | | | | 1.0 | | | | | | 0.6 | | | | | | | | 0.8 | |
| synthesis example 5 | A-1-5 | | | | | 1.0 | | | | | | 0.4 | | | 1.2 | | | | | |
| synthesis example 6 | A-1-6 | | | | | | 1.0 | | | | | | 0.1 | | | 1.6 | | | | 0.2 |
| synthesis example 7 | A-1-7 | 1.0 | | | | | | | | | | | | 0.1 | 1.2 | | 0.6 | | | |
| synthesis example 8 | A-1-8 | | | 1.0 | | | | | | | | | | | | | | 1.9 | | 0.1 |
| synthesis example 9 | A-1-9 | 0.5 | | 0.3 | 0.2 | | | 0.2 | | | | 0.5 | | | | 0.6 | | | | |
| synthesis example 10 | A-1-10 | | 0.5 | 0.5 | | | | | | | 0.3 | | 0.5 | | | | 0.2 | | 0.2 | |

inhibitor

| | |
|---|---|
| catalyst(g) | (g) |

| | | | | |
|---|---|---|---|---|
| benzyltriethyl- | 2,6-di- | [(a-2-1) + | reaction | reaction |

| | | | | | | | |
|---|---|---|---|---|---|---|---|
| monomer input | ammonium | tert-butyl- | solvent (g) | (a-3-1)]/ | temperature | time | acid value |

| component | | method | chloride | p-cresol | PGMEA | EEP | (a-1) | (° C.) | (hours) | | (mgKOH/g) | Mn |
|---|---|---|---|---|---|---|---|---|---|---|---|---|
| synthesis example 1 | A-1-1 | simultaneous addition | 1.9 | 0.6 | 750 | | 0.1 | 110 | 2 | | 129 | 2368 |
| synthesis example 2 | A-1-2 | successive addition | 2.0 | 0.7 | 700 | | 0.2 | 90 | 2 | 4 | 125 | 3388 |
| synthesis example 3 | A-1-3 | simultaneous addition | 2.9 | 1.0 | 1000 | 100 | 0.3 | 115 | 1.5 | | 87 | 4965 |
| synthesis example 4 | A-1-4 | successive addition | 1.1 | 0.4 | | 650 | 0.6 | 95 | 1.5 | 4 | 139 | 5201 |
| synthesis example 5 | A-1-5 | simultaneous addition | 1.3 | 0.4 | 650 | | 1.2 | 110 | 2 | | 144 | 3665 |
| synthesis example 6 | A-1-6 | successive addition | 1.1 | 0.4 | 600 | | 1.6 | 90 | 2 | 3.5 | 159 | 1885 |
| synthesis example 7 | A-1-7 | simultaneous addition | 1.9 | 0.6 | 800 | | 1.8 | 115 | 1.5 | | 113 | 1732 |
| synthesis example 8 | A-1-8 | successive addition | 2.9 | 1.0 | 1100 | | 1.9 | 95 | 2 | 3.5 | 87 | 1250 |
| synthesis example 9 | A-1-9 | simultaneous addition | 2.0 | 0.7 | | 850 | 0.8 | 110 | 2 | | 108 | 6023 |
| synthesis example 10 | A-1-10 | successive addition | 2.4 | 0.8 | 100 | 900 | 0.5 | 90 | 2 | 4 | 93 | 6802 |

TABLE 2
Synthesis of a second alkai-soluble resin (A-2)

| polymeric component | |
|---|---|
| | tetracarboxylic acid (a-2) or an acid |
| | dianhydride thereof (moles) |
| | tetracarboxylic acid |

| | | | | | | | | (a-2-1) or an acid | | | | |
|---|---|---|---|---|---|---|---|---|---|---|---|---|
| | | diol compound (a-1) containing a | | | | | | dianhydride thereof | | | | |
| | | polymeric unsaturated group (moles) | | | | | | containing a fluorine atom | | | | |
| component | | a-1-1 | a-1-2 | a-1-3 | a-1-4 | a-1-5 | a-1-6 | a-2-1-a | a-2-1-b | | a-2-1-c | a-2-1-d |
| synthesis | A-2-1 | 1.0 | | | | | | | | | | |
| example | | | | | | | | | | | | |
| 11 | | | | | | | | | | | | |
| synthesis | A-2-2 | | | 1.0 | | | | | | | | |
| example | | | | | | | | | | | | |
| 12 | | | | | | | | | | | | |
| synthesis | A-2-3 | | | | | 1.0 | | | | | | |
| example | | | | | | | | | | | | |
| 13 | | | | | | | | | | | | |
| | | polymeric component | | | | | | | | | | |
| | | | | | dicarboxylic acid (a-3) or an acid | | | | | | | |
| | | tetracarboxylic acid (a-2) or | | | anhydride thereof (moles) | | | | | | | |
| | | an acid dianhydride | | | | | | | other | | | |
| | | thereof (moles) | | | dicarboxylic acid | | | | dicarboxylic | | | |
| | | other tetracarboxylic | | | (a-3-1) or an acid | | | | acid (a-3-2) | | | |
| | | acid (a-2-2) or an | | | anhydride thereof | | | | or an acid | | | |
| | | acid dianhydride | | | containing a | | | | anhydride | | | monomer |
| | | thereof | | | fluorine atom | | | | thereof | | | input |
| component | | a-2-2-a | a-2-2-b | a-2-2-c | a-3-1-a | a-3-1-b | a-3-1-c | a-3-1-d | a-3-2-a | | a-3-2-b | method |
| synthesis | A-2-1 | 0.3 | | | | | | | 1.4 | | | simultaneous |
| example | | | | | | | | | | | | addition |
| 11 | | | | | | | | | | | | |
| synthesis | A-2-2 | | 0.6 | | | | | | | | 0.8 | successive |
| example | | | | | | | | | | | | addition |
| 12 | | | | | | | | | | | | |
| synthesis | A-2-3 | | | 0.8 | | | | | 0.4 | | | simultaneous |
| example | | | | | | | | | | | | addition |
| 13 | | | | | | | | | | | | |
| | | | inhibitor | | | | | | | | | |
| | | | (g) | | | | | | | | | |
| | | catalyst (g) | 2,6-di- | | | | | | | | | |
| | | benzyltriethyl- | tert- | | | | | reaction | reaction | | | |
| | | ammonium | butyl- | solvent (g) | | | | temperature | time | | acid value | |
| component | | chloride | p-cresol | PGMEA | EEP | (a-2)/(a-1) | (a-3)/(a-1) | (° C.) | (hours) | | (mgKOH/g) | Mn |
| synthesis | A-2-1 | 1.9 | 0.6 | 700 | | 0.0 | 0.0 | 110 | 2 | | 125 | 2455 |
| example | | | | | | | | | | | | |
| 11 | | | | | | | | | | | | |
| synthesis | A-2-2 | 2.9 | 0.0 | 950 | | 0.0 | 0.0 | 90 | 2 | 4 | 92 | 5130 |

| | | | | | | | | | | |
|---|---|---|---|---|---|---|---|---|---|---|
| example | | | | | | | | | | |
| 12 | | | | | | | | | | |
| synthesis | A-2-3 | 1.3 | 0.0 | 550 | 0.0 | 0.0 | 115 | 1.5 | 164 | 6542 |
| example | | | | | | | | | | |
| 13 | | | | | | | | | | |

In Table 1 and Table 2

a-1-1 Preparation Example 1 of a diol compound (a-1) containing a polymeric unsaturated group
a-1-2 Preparation Example 2 of a diol compound (a-1) containing a polymeric unsaturated group
a-1-3 Preparation Example 3 of a diol compound (a-1) containing a polymeric unsaturated group
a-1-4 Preparation Example 4 of a diol compound (a-1) containing a polymeric unsaturated group
a-1-5 Preparation Example 5 of a diol compound (a-1) containing a polymeric unsaturated group
a-1-6 Preparation Example 6 of a diol compound (a-1) containing a polymeric unsaturated group
a-2-1-a 4,4′-hexafluoro isopropylidene diphthalic dianhydride (6FDA)
a-2-1-b 1,4-difluoropyromellitic dianhydride
a-2-1-c 1,4-difluoropyromellitic dianhydride
a-2-1-d 1,4-bis(3,4-dicarboxytrifluorophenoxy)tetrafluoro benzenedianhydride
a-2-2-a biphenyl tetracarboxylic acid
a-2-2-b benzophenone tetracarboxylic dianhydride
a-2-2-c pyromellitic dianhydride
a-3-1-a 3-fluorophthalic anhydride
a-3-1-b 3,6-difluorophthalic anhydride
a-3-1-c 4-fluorophthalic anhydride
a-3-1-d tetrafluorobutanedioic anhydride
a-3-2-a maleic acid
a-3-2-b tetrahydrophthalic anhydride
PGMEA propylene glycol monomethyl ether acetate (PGMEA)
EEP ethyl 3-ethoxypropionate (EEP)

### Synthesis of an Other Alkai-Soluble Resin (A-3)

### Synthesis Example 14

A nitrogen inlet, a stirrer, a heater, a condenser tube, and a thermometer were provided to a four-neck round bottom flask having a volume of 1000 ml. After nitrogen was introduced, 15 parts by weight of acrylic acid (AA), 15 parts by weight of 2-hydroxyethyl methacrylate (HEMA), 10 parts by weight of benzyl methacrylate (BzMA), 60 parts by weight of CF₉BuMA, 3 parts by weight of 2,2′-azobis(2-methylbutyronitrile) (AMBN), and 300 parts by weight of diethylene glycol dimethyl ether (diglyme) were added. Then, the mixture was slowly stirred and the solution was heated to 80° C. Then, polycondensation was performed on the mixture at 80° C. for 6 hours. Then, after the solvent was evaporated, an alkali-soluble resin (A-3-1) can be obtained.

### Synthesis Example 15 to 16

The other alkali-soluble resins of synthesis example 15 to synthesis example 16 were prepared with the same steps as synthesis example 11, and the difference is: the kind, the used amount, the reaction time, the reaction temperature, and the addition time of the reactants of the components of the other alkali-soluble resins were changed (as shown in Table 3), wherein the compounds corresponding to the labels in Table 3 are as follows.

TABLE 3
Synthesis of an other alkai-soluble resin (A-3)

| | | composition | | | | | | | | | | | | | |
|---|---|---|---|---|---|---|---|---|---|---|---|---|---|---|---|
| | | | | | | | | monomer containing | | | | | | reaction | polycon- |
| | | | | | | | | fluorine | | solvent (parts | | initiator (parts | | temper- | densation |
| | | monomer (parts by weight) | | | | | | (parts by weight) | | by weight) | | by weight) | | ature | time |
| component | | MAA | AA | GMA | HEMA | BzMA | IBOMA | CF₉BuMA | CF₉PEMA | diglyme | PGMEA | AMBN | ADVN | (° C.) | (hours) |
| Synthesis | A-3-1 | | 15 | | 15 | 10 | | 60 | | 300 | | 3.0 | | 80 | 6 |
| Example | | | | | | | | | | | | | | | |
| 14 | | | | | | | | | | | | | | | |
| Synthesis | A-3-2 | 20 | | | 10 | | 10 | | 60 | | 300 | 3.0 | | 80 | 6 |
| Example | | | | | | | | | | | | | | | |
| 15 | | | | | | | | | | | | | | | |
| Synthesis | A-3-3 | 10 | 20 | 10 | | 20 | 40 | | | 300 | | | 2.0 | 80 | 6 |
| Example | | | | | | | | | | | | | | | |
| 16 | | | | | | | | | | | | | | | |

AMBN 2,2′-azobis-2-methyl butyronitrile
ADVN 2,2′-azobis(2,4-dimethylvaleronitrile)
MAA methacrylic acid
AA acrylic acid
GMA glycidyl methacylate
HEMA 2-hydroxyethyl methacrylate
BzMA benzyl methacrylate
IBOMA isobornyl methacrylate
CF₉BuMA CH₂═C(CH₃)COOCH₂CH₂CH₂CH₂OC₉F₁₇
CF₉PEMA CH₂═C(CH₃)COOCH₂CH₂OCOC₆H₄OC₉F₁₇
diglyme diethylene glycol dimethyl ether
PGMEA Propylene glycol monoethyl ether acetate
Diglym

### Synthesis of an α-Keto Oxime Ester Compound (C-1)

### Synthesis Example C-1-1

First, 100 grams of 2-(o-tolyl) acetic acid and 237 grams of thionyl acyl chloride were put under a nitrogen atmosphere, and then the temperature was raised to 95° C. gradually and flowed back for 4 hours. After 4 hours, the thionyl acyl chloride was distilled at 95° C. in room pressure. Then, after a reactor was cooled to room temperature, the residual thionyl acyl chloride was removed by a vacuum distillation equipment. Finally, the residual viscous liquid was precipitated and filtrated in petroleum ether, and 112 grams of yellow crystal was obtained. The yield of the yellow crystal was 71%. The yellow crystal was 2-(o-tolyl) acetyl chloride. The GC purity was 99%. The GC MASS was m/z=168.03.

Then, under a nitrogen atmosphere, 20 grams of N-ethylcarbazole was added and dissolved into 120 mL of CH₂Cl₂. After the reactant was cooled to 0° C., 14.07 grams of AlCl₃ was slowly added and 16.31 grams of o-toluene acyl chlorine was slowly dropped under the condition of internal temperature below 5° C. After the reactant was stirred for 5 hours at room temperature, the internal temperature was descended to 0° C., and 14.07 grams of AlCl₃ was slowly added and 17.79 grams of 2-(o-tolyl) acetyl chlorine was slowly dropped under the condition of internal temperature below 5° C. After the reactant was stirred for 8 hours at room temperature, the internal temperature was descended to 0° C., and 300 mL of cooled water was slowly added into the solution of the reactor and stirred for 1 hour. Then, layers were separated and each layer was neutralized and washed by 200 mL of 1% NaOH. An organic layer was dried by MgSO₄, and the solvent was removed by a rotary evaporator. Then, the organic layer was recrystallized by ethyl acetate and methylene chloride. 35 grams of white solid was obtained. The yield of the white solid was 77%. The white solid was 1-(9-ethyl-6-(2-methylbenzoyl)-9H-carbazol-3-yl)-2-(o-tolyl)ethanone.

180 mL of dimethylformamide was put into the reactor, and 30 grams of the aforementioned white solid was added into the reactor to be dissolved. 1.82 grams of sodium methoxide was slowly added into the reaction water at 15° C. The internal temperature was maintained at 15° C. and 8.13 grams of amyl nitrite was dropped slowly. Then, the temperature was raised to 25° C. and stirred 8 hours. 200 mL of ethyl acetate solvent and 200 mL of distilled water was added to rinse the reactants. After the reactants were additionally rinsed twice, dimethylformamide was removed. Then the reactant was neutralized and washed by saturated calcium carbonate. An organic layer was dried by MgSO₄. After distillation at reduced pressure, a liquid compound was obtained. Finally, methanol and methylene chloride were added to recrystallize the liquid compound. 20 grams of light yellow crystal was obtained. The yield of the light yellow crystal was 63%. The light yellow crystal was (E)-1-(9-ethyl-6-(2-methylbenzoyl)-9H-carbazol-3-yl)-2-(hydroxyimino)-2-(o-tolyl) ethanone.

Finally, under a nitrogen atmosphere, the internal temperature of the reactor was descended to below 0° C., and 20 grams of the aforementioned light yellow crystal, 120 mL of dichloromethane and 4.4 grams of triethylamine were added. Then, a solution formed by 3.42 grams of acetyl chlorine and 10 mL dichloromethane was slowly dropped into the reactor. After the internal temperature was raised to 10° C., the reactant solution was stirred for 3 hours. The organic layer was washed by adding water to the reactant solution repeatedly. After distillation at reduced pressure, a solid compound was obtained. Lastly, ethyl acetate and methylene chloride were added to recrystallize After filtered, 17 grams of light yellow solid was obtained. The yield of the light yellow solid was 78%. The light yellow solid was (E)-2-(acetoxyimino)-1-(9-ethyl-6-(2-methylbenzoyl)-9H-carbazol-3-yl)-2-(o-tolyl) ethanone. That is, the α-keto oxime ester compound (C-1) represented by Formula (7-1).

### Synthesis Example C-1-2 to C-1-6

The α-keto oxime ester compound (C-1) of synthesis example C-1-2 to C-1-6 were prepared with the same steps as synthesis example C-1-1 and represented as following: Formula (7-2), Formula (7-4), Formula (7-6), Formula (7-7) and Formula (7-10).

### Example of Photosensitive Resin

### Example 1

100 parts by weight of the first alkali-soluble resin (A-1-1), 20 parts by weight of trimethylolpropane triacrylate (B-1), 10 parts by weight of a-keto oxime ester compound (C-1-1) represented by Formula (7-1), and 140 parts by weight of C.I. Pigment BK7 (E-1) were added to 1600 parts by weight of propylene glycol monomethyl ether acetate (D-1) and uniformly stirred with a shaking type stirrer to obtain the photosensitive resin composition of Example 1. The obtained photosensitive resin composition was evaluated by each of the following evaluation methods, and the results are as shown in Table 4.

### Examples 2 to 10

The Examples 2 to 10 are similar to Example 1 were prepared with the same steps as Example 1 except the kind, the used amount (shown as Table 4) of the components of the photosensitive resin. The compounds corresponding to the labels of Table 4 are as shown below. The evaluation results are listed in Table 4.

### Comparative Examples 1 to 7

The Comparative Examples 1 to 7 are similar to Example 1 were prepared with the same steps as Example 1 except the kind, the used amount (shown as Table 5) of the components of the photosensitive resin. The evaluation results are listed in Table 5.

<Assays>

Resolution:

The photosensitive resin composition obtained in each example and comparative example was coated on a glass substrate with a spin coating method. Then, the glass substrate was pre-baked at 100° C. for 2 minutes to obtain a pre-baked coating film of about 1.2 μm. Then, the pre-baked coating film was placed under a line and space photomask (made by Nibbon Filcon, Japan) and exposed with an ultraviolet light (model of exposure machine: AG500-4N, made by M&R Nano Technology) at 50 mJ/cm². Then, the pre-baked coating film was developed with a 0.045% aqueous solution of potassium hydroxide at 23° C. for 1 minute to remove the unexposed portion of the coating film on the substrate. Then, the glass substrate having a specific pattern was rinsed with water. Lastly, the minimum value of the line width magnitude of the pattern formed on the glass substrate was defined as the resolution. The line width magnitude was evaluated with the following methods. It should be mentioned that, a smaller minimum pattern line width represents better resolution of the photosensitive resin composition.

⊚: minimum pattern line width≦4 μm

◯: 4 μm<minimum pattern line width≦6 μm

Δ: 6 μm<minimum pattern line width≦8 μm

X: 8 μm<minimum pattern line width

Taper Angle

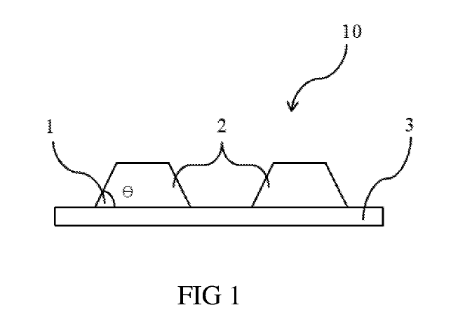

The photosensitive resin composition obtained in each example and comparative example was coated on a glass substrate with a spin coating method. Then, the glass substrate was pre-baked at 100° C. for 2 minutes to obtain a pre-baked coating film of about 1.2 μm. Then, the pre-baked coating film was exposed under a photomask (model of exposure machine: AG500-4N, made by M&R Nano Technology). Then, the pre-baked coating film was developed with a 0.045% aqueous solution of potassium hydroxide at 23° C. for 1 minute to remove the unexposed portion of the coating film on the substrate. Then, the glass substrate having a specific pattern was rinsed with water to obtain a photoresist pattern. The taper angle of the photoresist pattern was observed by the scanning electron microscope (model of scanning electron microscope: S-4800, made by Hitachi High-Technologies) (referred to FIG. 1).

⊚: 50°≦Taper Angle≦60°

◯: 60°<Taper Angle≦65° or 45°≦Taper Angle<50°

Δ: 65°<Taper Angle≦80° or 30°≦Taper Angle<45°

X: 80°<Taper Angle or Taper Angle<30°

TABLE 4

| | | | example | | | | | | | | | |
|---|---|---|---|---|---|---|---|---|---|---|---|---|
| component | | | 1 | 2 | 3 | 4 | 5 | 6 | 7 | 8 | 9 | 10 |
| alkali-soluble | A-1 | A-1-1 | 100 | | | | | | | | | |
| resin (A) | | A-1-2 | | 100 | | | | | | | | |
| (parts by | | A-1-3 | | | 100 | | | | | | | |
| weight) | | A-1-4 | | | | 90 | | | | | | |
| | | A-1-5 | | | | | 80 | | | | | |
| | | A-1-6 | | | | | | 75 | | | | |
| | | A-1-7 | | | | | | | 50 | | | |
| | | A-1-8 | | | | | | | | 45 | | |
| | | A-1-9 | | | | | | | | | 30 | |
| | | A-1-10 | | | | | | | | | | 20 |
| | A-2 | A-2-1 | | | | 10 | | 25 | | 40 | | |
| | | A-2-2 | | | | | 20 | | | | 50 | |
| | | A-2-3 | | | | | | | 50 | | | 80 |
| | A-3 | A-3-1 | | | | | | | | 15 | | |
| | | A-3-2 | | | | | | | | | 20 | |
| | | A-3-3 | | | | | | | | | | |
| compound | B -1 | | 20 | | 80 | | | 30 | | | | 160 |
| (B) | B -2 | | | 30 | | 100 | | | 140 | | 180 | |
| containing an | B -3 | | | 10 | | | 120 | | | 60 | | |
| ethylenically | | | | | | | | | | | | |
| unsaturated | | | | | | | | | | | | |
| group | | | | | | | | | | | | |
| (parts by | | | | | | | | | | | | |
| weight) | | | | | | | | | | | | |
| photoinitiator | C-1 | C-1-1 | 10 | | | | | | | 30 | 25 | |
| (C) | | C-1-2 | | 20 | | | | | 10 | | | |
| (parts by | | C-1-3 | | | 35 | | | | 15 | | | 70 |
| weight) | | C-1-4 | | | | 45 | | | | | | |
| | | C-1-5 | | | | | 60 | | | | | |
| | | C-1-6 | | | | | | 55 | | | | |
| | C-2 | C-2-1 | | 5 | | | | | | | | |
| | | C-2-2 | | | | | | | | | | 10 |
| | | C-2-3 | | | | 1 | | | | | | |
| | | C-2-4 | | | | | | | | | 8 | |

| | | | | | | | | | | | |
|---|---|---|---|---|---|---|---|---|---|---|---|
| solvent (D) | D-1 | 1600 | | 1000 | 1000 | 4200 | | 6500 | | 5000 | 2000 |
| (parts by | D-2 | | 2000 | | 2500 | | 2600 | | 7300 | | 6000 |
| weight) | | | | | | | | | | | |
| black | E-1 | 140 | | 430 | | 650 | | 1100 | | 800 | 1200 |
| pigment (E) | E-2 | | 260 | | 580 | | 800 | | 1050 | 100 | |
| (parts by | | | | | | | | | | | |
| weight) | | | | | | | | | | | |
| thermal | F-1 | | 4 | | | | | | | | |
| initiator (F) | F-2 | | | 15 | | | | | | 40 | |
| (parts by | F-3 | | | | | | 25 | | | | |
| weight) | | | | | | | | | | | |
| additive (G) | G-1 | | | 0.06 | | | | | | | |
| (parts by | G-2 | | | | | | | 3 | | | |
| weight) | | | | | | | | | | | |
| assay | resolution | ◯ | ⊚ | ⊚ | ⊚ | ⊚ | ⊚ | ◯ | ◯ | ⊚ | ⊚ |
| | taper angle | ◯ | ◯ | ◯ | ◯ | ◯ | ◯ | ◯ | ◯ | ◯ | ◯ |

TABLE 5

| | | | comparative example | | | | | |
|---|---|---|---|---|---|---|---|---|
| component | | | 1 | 2 | 3 | 4 | 5 | 6 |
| alkali-soluble | A-1 | A-1-1 | | | | | 100 | |
| resin (A) | | A-1-2 | | | | | | |
| (parts by | | A-1-3 | | | | | | |
| weight) | | A-1-4 | | | | | | |
| | | A-1-5 | | | | | | |
| | | A-1-6 | | | | | | |
| | | A-1-7 | | | | | | |
| | | A-1-8 | | | | | | |
| | | A-1-9 | | | | | | |
| | | A-1-10 | | | | | | |
| | A-2 | A-2-1 | 100 | | | | | 100 |
| | | A-2-2 | | 100 | | | | |
| | | A-2-3 | | | | | | |
| | A-3 | A-3-1 | | | 100 | | | |
| | | A-3-2 | | | | | | |
| | | A-3-3 | | | | 100 | | |
| compound (B) | B-1 | | 100 | | | 80 | | |
| containing an | B-2 | | | 80 | | | 100 | |
| ethylenically | B-3 | | | | 100 | | | 100 |
| unsaturated | | | | | | | | |
| group | | | | | | | | |
| (parts by | | | | | | | | |
| weight) | | | | | | | | |
| photoinitiator | C-1 | C-1-1 | 35 | | | 35 | | |
| (C) | | C-1-2 | | 40 | | | | |
| (parts by | | C-1-3 | | | 40 | | | |
| weight) | | C-1-4 | | | | | | |
| | | C-1-5 | | | | | | |
| | | C-1-6 | | | | | | |
| | C-2 | C-2-1 | | | | | 35 | |
| | | C-2-2 | | | | | | 35 |
| | | C-2-3 | | | | | | |
| | | C-2-4 | | | | | | |

| | | | | | | | |
|---|---|---|---|---|---|---|---|
| solvent (D) | D-1 | 2000 | | 2000 | 2000 | 2000 | |
| (parts by | D-2 | | 2000 | | | | 2000 |
| weight) | | | | | | | |
| black pigment | E-1 | 580 | 580 | 580 | | | |
| (E) | E-2 | | | | 580 | 580 | 580 |
| (parts by | | | | | | | |
| weight) | | | | | | | |
| thermal | F-1 | | | | | | |
| initiator | F-2 | | | | | | |
| (F) | F-3 | | | | | | |
| (parts by | | | | | | | |
| weight) | | | | | | | |
| additive (G) | G-1 | | | | | | |
| (parts by | G-2 | | | | | | |
| weight) | | | | | | | |
| assay | resolution | X | X | X | X | X | X |
| | taper angle | ◯ | ◯ | ◯ | ◯ | X | X |

In Table 4 and Table 5:
B-1 trimethylolpropane triacrylate
B-2 dipentaerythritol tetracrylate
B-3 dipentaerythritol hexaacrylate
C-1-1 α-keto oxime ester compound represented by Formula (7-1)
C-1-2 α-keto oxime ester compound represented by Formula (7-2)
C-1-3 α-keto oxime ester compound represented by Formula (7-4)
C-1-4 α-keto oxime ester compound represented by Formula (7-6)
C-1-5 α-keto oxime ester compound represented by Formula (7-7)
C-1-6 α-keto oxime ester compound represented by Formula (7-10)
1-[9-ethyl-6-(2-methylbenzoyl)-9H-carbazol-3-yl]-ethanone 1-(O-
C-2-1 acetyloxime) (product name OXE-02 manufactured by Ciba Specialty
Chemicals)
C-2-2 1-[4-(phenylthio)phenyl]-octane-1,2-dione 2-(O-benzoyloxime) (product name OXE-01 manufactured by Ciba Specialty Chemicals)
C-2-3 2-methyl-1-(4-methylthio phenyl)-2-morpholino-1-propanone
C-2-4 2,2′-bis(2,4-dichlorophenyl)-4,4′,5,5′-tetraphenyl-biimidazole
D-1 propylene glycol methyl monoether acetate
D-2 ethyl 3-ethoxypropionate
E-1 C.I. Pigment BK7
E-2 MA100 (manufactured by Mitsubishi Chemical Co., Ltd)
F-1 2,2′-azobis(2,4-dimethylvaleronitrile)
F-2 cumyl peroxyneodecanoate
F-3 p-menthane hydroperoxide
G-1 SF-8427((manufactured by Toray Dow Corning Silicone Co., Ltd.) 3-glycidoxypropyltrimethoxysilane (product name KBM403, Shin-Etsu
G-2

Chemical Co., Ltd.)

While embodiments of the present invention have been illustrated and described, various modifications and improvements can be made by persons skilled in the art. It is intended that the present invention is not limited to the particular forms as illustrated, and that all modifications not departing from the spirit and scope of the present invention are within the scope as defined in the following claims.

What is claimed is:

1. A photosensitive resin composition comprising:
an alkali-soluble resin (A);
a compound (B) containing an ethylenically unsaturated group;
a photoinitiator (C);
a solvent (D); and
a black pigment (E);
wherein:
the alkali-soluble resin (A) comprises a first alkali-soluble resin (A-1) represented by Formula (1): 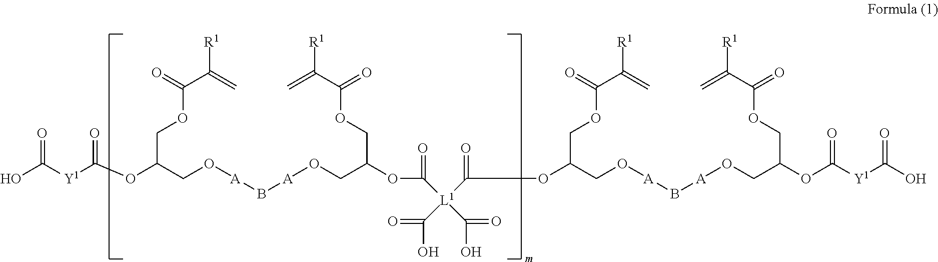
in Formula (1):
A represents a phenylene group or a phenylene group having a substituent, wherein the substituent is a C₁-C₅ alkyl group, a halogen atom, or a phenyl group;
B represents —CO—, —SO₂—, —C(CF₃)₂—, —Si(CH₃)₂—, —CH₂—, —C(CH₃)₂—, —O—, 9,9-fluorenylidene or a single bond;
L¹ represents a tetravalent carboxylic acid residue containing a fluorine atom or a tetravalent carboxylic acid residue without a fluorine atom;
Y¹ represents a divalent carboxylic acid residue containing a fluorine atom or a divalent carboxylic acid residue without a fluorine atom;
R¹ represents a hydrogen atom or a methyl group; and
m represents an integer of 1 to 20;
wherein at least one of L¹ and Y¹ contains the fluorine atom;
the photoinitiator (C) comprises an α-keto oxime ester compound (C-1) represented by Formula (7): 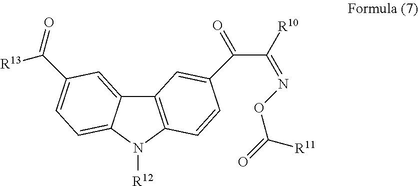
in Formula (7):
R¹⁰ represents a methylbenzene group having 1 to 5 methyl groups;
R¹¹ represents a C₁-C₁₀ alkyl group, a benzoyl group, or a C₃-C₆ cycloalkyl group,
R¹² represents a methyl group, an ethyl group, a propyl group or a benzoyl group; and
R¹³ represents —H, 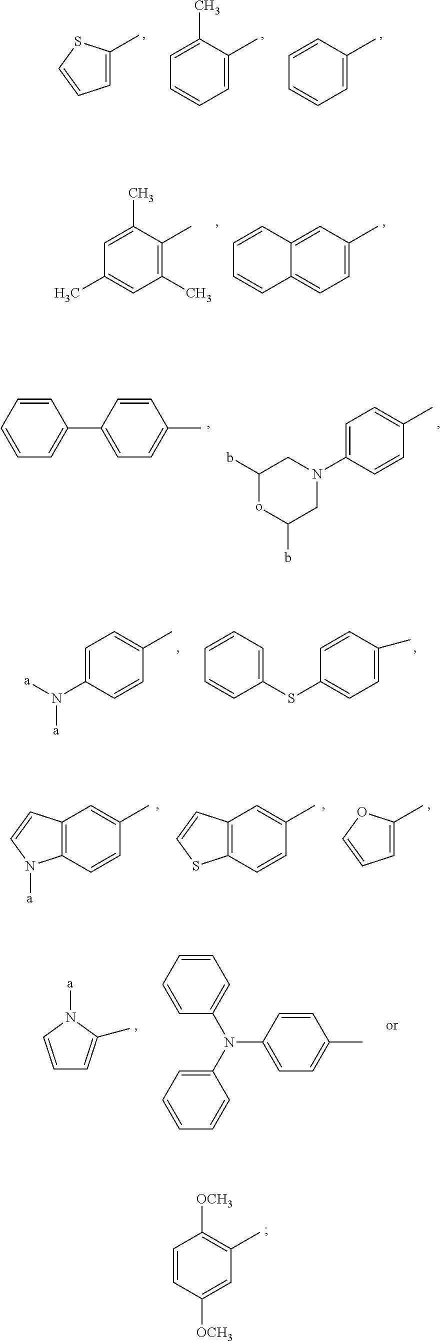
wherein, a represents a methyl group or an ethyl group; and
b represents —H or a methyl group.

2. The photosensitive resin composition according to claim 1, wherein the alkali-soluble resin (A-1) is obtained by reacting a first mixture, the first mixture comprising:
a diol compound (a-1) containing a polymeric unsaturated group;
a tetracarboxylic acid (a-2) or an acid dianhydride thereof; and
a dicarboxylic acid (a-3) or an acid anhydride thereof;
wherein the tetracarboxylic acid (a-2) or the acid dianhydride thereof comprises a tetracarboxylic acid (a-2-1) or an acid dianhydride thereof containing a fluorine atom, an other tetracarboxylic acid (a-2-2) or an acid dianhydride thereof other than the tetracarboxylic acid (a-2-1) or the acid dianhydride thereof containing the fluorine atom, or a combination of the two;
the dicarboxylic acid (a-3) or the acid anhydride thereof comprises a dicarboxylic acid (a-3-1) or an acid anhydride thereof containing a fluorine atom, an other dicarboxylic acid (a-3-2) or an acid anhydride thereof other than the dicarboxylic acid (a-3-1) or the acid anhydride thereof containing the fluorine atom, or a combination of the two; and
at least one of the tetracarboxylic acid (a-2) or the acid dianhydride thereof and the dicarboxylic acid (a-3) or the acid anhydride thereof contains the fluorine atom.

3. The photosensitive resin composition according to claim 2,
wherein the tetracarboxylic acid (a-2-1) or the acid dianhydride thereof containing the fluorine atom is selected from the group consisting of a tetracarboxylic acid compound containing a fluorine atom represented by Formula (2-1) and a tetracarboxylic acid dianhydride compound containing a fluorine atom represented by Formula (2-2): 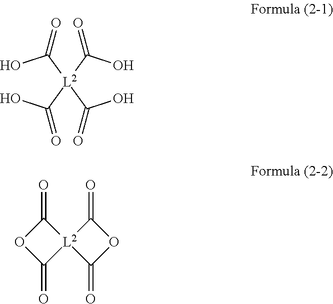
in Formula (2-1) and Formula (2-2), L² is selected from groups represented by Formula (L-1) to Formula (L-6), 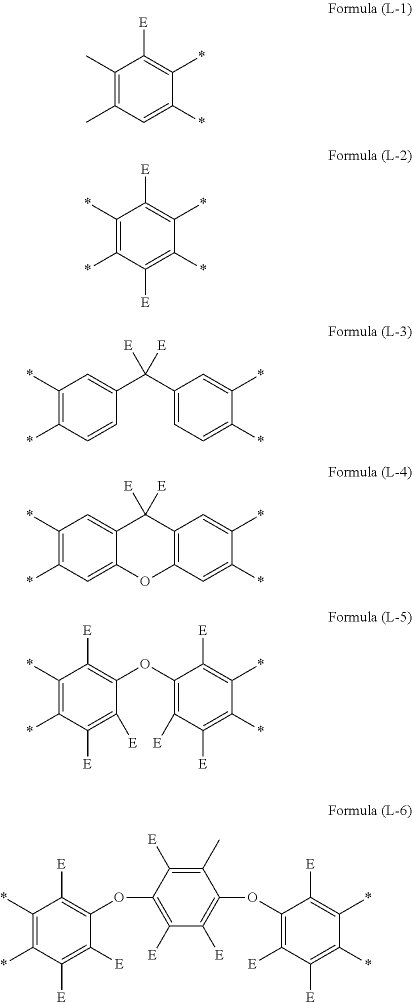
in Formula (L-1) to Formula (L-6), E independently represents a fluorine atom or a trifluoromethyl group; and * represents a binding position with a carbon atom.

4. The photosensitive resin composition according to claim 2, wherein in the alkali-soluble resin (A-1), the dicarboxylic acid (a-3-1) or the acid anhydride thereof containing the fluorine atom is selected from the group consisting of a dicarboxylic acid compound containing a fluorine atom represented by Formula (3-1) and a dicarboxylic acid anhydride compound containing a fluorine atom represented by Formula (3-2): 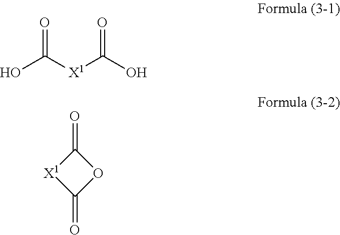
in Formula (3-1) and Formula (3-2), X¹ represents a C₁ to C₁₀₀ organic group containing a fluorine atom.

5. The photosensitive resin composition according to claim 2, wherein a molar number of the diol compound (a-1) containing the polymeric unsaturated group, a molar number of the tetracarboxylic acid (a-2-1) or the acid dianhydride thereof containing the fluorine atom, and a molar number of the dicarboxylic acid (a-3-1) or the acid anhydride thereof containing the fluorine atom satisfy an equation of [(a-2-1)+(a-3-1)]/(a-1)=0.4 to 1.6.

6. The photosensitive resin composition according to claim 1, further comprising a thermal initiator (F), wherein the thermal initiator is at least one compound selected from the group consisting of an azo compound, a peroxide compound, and a hydrogen peroxide compound.

7. The photosensitive resin composition according to claim 6, wherein the azo compound is selected from the group consisting of 2,2′-azobis(isobutyronitrile), 2,2′-azobis-2-methyl butyronitrile, 1,1′-azobis(cyclohexane-1-carbonitrile), 2,2′-azobis(2,4-dimethylvaleronitrile), 1-[(1-cyano-1-methylethyl)azo]formamide, 2,2-azobis{2-methyl-N-[1,1-bis(hydroxymethyl)-2-hydroxyethyl]propionamide, 2,2′-azobis[N-(2-propenyl)-2-methylpropionamide, 2,2′-azobis[N-(2-propenyl)-2-ethyl propionamide, 2,2′-azobis(N-butyl-2-methylpropionamide), 2,2′-azobis(N-cyclohexyl-2-methyl propionamide), 2,2′-azobis(dimethyl-2-methyl propionamide), 2,2′-azobis(dimethyl-2-methyl propionate) and 2,2′-azobis(2,4,4-trimethyl pentene).

8. The photosensitive resin composition according to claim 6, wherein the peroxide compound is selected from the group consisting of benzoyl peroxide, tertiary butyl peroxide, diisobutyryl peroxide, cumyl peroxyneodecanoate, di-n-propyl peroxydicarbonate, diisopropyl peroxydicarbonate, di-sec-butyl peroxydicarbonate, 1,1,3,3-tetramethylbutyl peroxyneodecanoate, di(4-t-butyl cyclohexyl) peroxydicarbonate, 1-cyclohexyl-1-methylethyl peroxyneodecanoate, di(2-ethoxy-ethyl) peroxydicarbonate, di(2-ethylhexyl) peroxydicarbonate, t-hexyl peroxyneodecanoate, dimethoxybutyl peroxydicarbonate, t-butyl peroxyneodecanoate, t-hexyl peroxypivalate, t-butyl peroxypivalate, di(3,5,5-trimethyl hexanoyl) peroxide, di-n-octanoyl peroxide, dilauroyl peroxide, distearoyl peroxide, 1,1,3,3-tetramethylbutylperoxy-2-ethylhexanoate, 2,5-dimethyl-2,5-di(2-ethylhexanoylperoxy)hexane, t-hexylperoxy-2-ethylhexanoate, di(4-methylbenzoyl) peroxide, t-butylperoxy-2-ethylhexanoate, dibenzoyl peroxide, t-butyl peroxyisobutyrate, 1,1-di(t-butyl peroxy)-2-methylcyclohexane, 1,1-di(t-hexyl peroxy)-3,3,5-trimethylcyclohexane, 1,1-di(t-hexylperoxy) cyclohexane, 1,1-di(t-butylperoxy) cyclohexane, 2,2-di[4,4-di(t-butylperoxy) cyclohexyl] propane, t-hexyl peroxy isopropyl monocarbonate, t-butylperoxy maleate, t-butyl peroxy-3,5,5-trimethyl hexanoate, t-butyl peroxy laurate, 2,5-dimethyl-2,5-di-(3-methyl benzoyl peroxy)hexane, t-butyl peroxy isopropyl monocarbonate, t-butyl peroxy-2-ethylhexyl monocarbonate, t-hexyl peroxy benzoate, 2,5-dimethyl-2,5-di(benzoyl peroxy)hexane, t-butyl peroxy acetate, 2,2-di(t-butylperoxy) butane, t-butyl peroxy benzoate, n-butyl-4,4-di(t-butylperoxy) valerate, di(2-t-butyl peroxy isopropyl) benzene, dicumyl peroxide, di-t-hexyl peroxide, 2,5-dimethyl-2,5-di(t-butyl peroxy) hexane, di-t-butyl peroxide, 2,5-dimethyl-2,5-di(t-butylperoxy) hexyne, t-butyl trimethylsilyl peroxide, di(3-methylbenzoyl) peroxide, benzoyl (3-methylbenzoyl) peroxide and dibenzoyl peroxide.

9. The photosensitive resin composition according to claim 6, wherein the hydrogen peroxide compound is selected from the group consisting of p-menthane hydroperoxide, diisopropylbenzene hydroperoxide, 1,1,3,3-tetramethyl butyl hydroperoxide, cumene hydroperoxide and t-butyl hydroperoxide.

10. The photosensitive resin composition according to claim 1, wherein based on 100 parts by weight of the used amount of the alkali-soluble resin (A), the used amount of the first alkali-soluble resin (A-1) represented by Formula (1) is from 20 parts by weight to 100 parts by weight; the used amount of the compound (B) containing the ethylenically unsaturated group is from 20 parts by weight to 180 parts by weight; the used amount of the photoinitiator (C) is from 10 parts by weight to 80 parts by weight; the used amount of the a-keto oxime ester compound (C-1) represented by Formula (7) is from 10 parts by weight to 70 parts by weight; the used amount of the solvent (D) is from 1000 parts by weight to 8000 parts by weight; and the black pigment (E) is from 140 parts by weight to 1200 parts by weight.

11. The photosensitive resin composition according to claim 6, wherein based on 100 parts by weight of the used amount of the alkali-soluble resin (A), the used amount of the thermal initiator (F) is from 4 parts by weight to 40 parts by weight.

12. A black matrix formed by the photosensitive resin composition according to claim 1.

13. A color filter comprising the black matrix according to claim 12.

14. A liquid crystal display element comprising the color filter according to claim 13.
